(19) United States
(12) Patent Application Publication
(10) Pub. No.: US 2025/0202675 A1
(43) Pub. Date: Jun. 19, 2025

(54) DUPLEX INFORMATION EXCHANGE WITHIN A WIRELESS COMMUNICATIONS NETWORK

(71) Applicant: QUALCOMM Incorporated, San Diego, CA (US)

(72) Inventors: Shankar KRISHNAN, San Diego, CA (US); Prasad Reddy KADIRI, San Diego, CA (US); Muhammad Sayed Khairy ABDELGHAFFAR, San Jose, CA (US); Chiranjib SAHA, Lakeside, CA (US)

(21) Appl. No.: 18/545,903

(22) Filed: Dec. 19, 2023

(51) Int. Cl. H04L 5/14; H04L 5/16; H04W 72/0453; H04W 72/231

(52) U.S. Cl. CPC H04L 5/1469; H04L 5/16; H04W 72/0453; H04W 72/231

(57) ABSTRACT

Methods, systems, and devices for wireless communications are described. The described techniques may enable a distributed unit (DU) to transmit backhaul signaling to a central unit (CU) indicating duplex information. For example, the duplex information may indicate an active duplex mode (e.g., subband full-duplex, subband half-duplex, or full-duplex), frequency or time information related to one or more duplex modes, or a random access channel (RACH) configuration that is specific to one or more duplex modes. In some examples, the CU may forward the duplex information to another CU or DU. Additionally, or alternatively, one or more network entities may transmit the duplex information to a user equipment (UE). For example, the one or more network entities may indicate multiple duplex configurations to the UE, and may transmit signaling activating one of the multiple duplex configurations.

### FIELD OF TECHNOLOGY

The following relates to wireless communications, including duplex information exchange within a wireless communications network.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

In some wireless communications systems, a network entity may communicate with a user equipment (UE) using one or more duplex modes (e.g., subband full-duplex (SBFD), subband half-duplex (SBHD), or full-duplex (FD) such as (IBFD)). The described techniques relate to improved methods, systems, devices, and apparatuses that support duplex information exchange within a wireless communications network. For example, a distributed unit (DU) may transmit backhaul signaling to a central unit (CU) indicating duplex information. In some examples, the duplex information may indicate an active duplex mode (e.g., subband full-duplex, subband half-duplex, or in-band full-duplex), frequency or time information related to one or more duplex modes, or a random access channel (RACH) configuration that is specific to one or more duplex modes. In some examples, the CU may forward the duplex information to another network entity (e.g., another CU or DU for use in a handover procedure). Additionally, or alternatively, one or more network entities (e.g., the DU, the CU, a different DU) may transmit the duplex information to the UE. For example, the one or more network entities may indicate multiple duplex configurations to a UE (e.g., via a system information block (SIB), radio resource control (RRC), medium access control-control element (MAC-CE), or downlink control information (DCI)), and may transmit signaling (e.g., via MAC-CE or DCI) activating one of the multiple duplex configurations.

A method for wireless communications by a first network entity is described. The method may include outputting duplex information for one or more cells associated with the first network entity, where the duplex information includes information related to a SBFD mode, a SBHD mode, a FD mode, or any combination thereof for the one or more cells, and communicating, via a cell of the one or more cells, with a UE in accordance with the duplex information.

A first network entity for wireless communications is described. The first network entity may include one or more memories storing processor executable code, and one or more processors coupled with the one or more memories. The one or more processors may individually or collectively be operable to execute the code to cause the first network entity to output duplex information for one or more cells associated with the first network entity, where the duplex information includes information related to a SBFD mode, a SBHD mode, a FD mode, or any combination thereof for the one or more cells, and communicate, via a cell of the one or more cells, with a UE in accordance with the duplex information.

Another first network entity for wireless communications is described. The first network entity may include means for outputting duplex information for one or more cells associated with the first network entity, where the duplex information includes information related to a SBFD mode, a SBHD mode, a FD mode, or any combination thereof for the one or more cells, and means for communicating, via a cell of the one or more cells, with a UE in accordance with the duplex information.

A non-transitory computer-readable medium storing code for wireless communications is described. The code may include instructions executable by one or more processors to output duplex information for one or more cells associated with the first network entity, where the duplex information includes information related to a SBFD mode, a SBHD mode, a FD mode, or any combination thereof for the one or more cells, and communicate, via a cell of the one or more cells, with a UE in accordance with the duplex information.

In some examples of the method, first network entities, and non-transitory computer-readable medium described herein, the duplex information may be output to a second network entity and the method, apparatuses, and non-transitory computer-readable medium may include further operations, features, means, or instructions for receiving, from the second network entity, a second message including at least a subset of the duplex information and forwarding the second message to the UE.

In some examples of the method, first network entities, and non-transitory computer-readable medium described herein, the duplex information includes a set of multiple duplex configurations and the method, apparatuses, and non-transitory computer-readable medium may include further operations, features, means, or instructions for outputting a control message to activate one of the set of multiple duplex configurations, where the communicating with the UE may be in accordance with the activated one of the set of multiple duplex configurations.

In some examples of the method, first network entities, and non-transitory computer-readable medium described herein, the duplex information indicates an active duplex mode for a first cell of the one or more cells, a random access channel configuration associated with an active duplex mode for the first cell, or both, the active duplex mode including, one or more of one of the SBFD mode, the SBHD mode, or the FD mode.

In some examples of the method, first network entities, and non-transitory computer-readable medium described herein, the duplex information indicates frequency information for at least one mode from among the SBFD mode, the SBHD mode, or the FD mode, the frequency information including an uplink frequency range, a downlink frequency range, a guard band frequency range, or any combination thereof for the at least one mode, a SCS for the at least one mode, a frequency offset for the at least one mode, or any combination thereof.

In some examples of the method, first network entities, and non-transitory computer-readable medium described herein, the duplex information indicates a type of frequency domain allocation for one or more time periods, the type of frequency domain allocation including a pattern of one or more downlink allocations and one or more uplink allocations within the one or more time periods.

In some examples of the method, first network entities, and non-transitory computer-readable medium described herein, the duplex information indicates time information for at least one mode from among the SBFD mode, the SBHD mode, or the FD mode, the time information including one or more time periods in which the at least one mode may be active, a periodicity for the at least one mode, one or more respective communication directions for the one or more time periods, or any combination thereof.

In some examples of the method, first network entities, and non-transitory computer-readable medium described herein, the first network entity may be a DU.

A method for wireless communications by a second network entity is described. The method may include obtaining duplex information for one or more cells associated with a first network entity, where the duplex information includes information related to a SBFD mode, a SBHD mode, a FD mode, or any combination thereof for the one or more cells, outputting, to a communications device, one or more messages indicating the duplex information, and performing one or more operations in accordance with the duplex information.

A second network entity for wireless communications is described. The second network entity may include one or more memories storing processor executable code, and one or more processors coupled with the one or more memories. The one or more processors may individually or collectively be operable to execute the code to cause the second network entity to obtain duplex information for one or more cells associated with a first network entity, where the duplex information includes information related to a SBFD mode, a SBHD mode, a FD mode, or any combination thereof for the one or more cells, output, to a communications device, one or more messages indicating the duplex information, and perform one or more operations in accordance with the duplex information.

Another second network entity for wireless communications is described. The second network entity may include means for obtaining duplex information for one or more cells associated with a first network entity, where the duplex information includes information related to a SBFD mode, a SBHD mode, a FD mode, or any combination thereof for the one or more cells, means for outputting, to a communications device, one or more messages indicating the duplex information, and means for performing one or more operations in accordance with the duplex information.

A non-transitory computer-readable medium storing code for wireless communications is described. The code may include instructions executable by one or more processors to obtain duplex information for one or more cells associated with a first network entity, where the duplex information includes information related to a SBFD mode, a SBHD mode, a FD mode, or any combination thereof for the one or more cells, output, to a communications device, one or more messages indicating the duplex information, and perform one or more operations in accordance with the duplex information.

In some examples of the method, second network entities, and non-transitory computer-readable medium described herein, the duplex information includes a set of multiple duplex configurations, and the method, apparatuses, and non-transitory computer-readable medium may include further operations, features, means, or instructions for obtaining a third message indicating at least one of the set of multiple duplex configurations.

In some examples of the method, second network entities, and non-transitory computer-readable medium described herein, the third message indicates at least one time duration during which the at least one of the set of multiple duplex configuration may be active.

Some examples of the method, second network entities, and non-transitory computer-readable medium described herein may further include operations, features, means, or instructions for receiving, from a third network entity, a request for the duplex information, where outputting the duplex information to the communications device includes outputting the duplex information to the third network entity.

In some examples of the method, second network entities, and non-transitory computer-readable medium described herein, the duplex information indicates an active duplex mode for a first cell of the one or more cells, a random access channel configuration associated with an active duplex mode for the first cell, or both, the active duplex mode including one or more of the SBFD mode, the SBHD mode, or the FD mode.

In some examples of the method, second network entities, and non-transitory computer-readable medium described herein, the duplex information indicates frequency information for at least one mode from among the SBFD mode, the SBHD mode, or the FD mode, the frequency information including an uplink frequency range, a downlink frequency range, a guard band frequency range, or any combination thereof for the at least one mode, a SCS for the at least one mode, a frequency offset for the at least one mode, or any combination thereof.

In some examples of the method, second network entities, and non-transitory computer-readable medium described herein, the duplex information indicates a type of frequency domain allocation for one or more time periods, the type of frequency domain allocation including a pattern of one or more downlink allocations and one or more uplink allocations within the one or more time periods.

In some examples of the method, second network entities, and non-transitory computer-readable medium described herein, the duplex information indicates time information for at least one mode from among the SBFD mode, the SBHD mode, or the FD mode, the time information including one or more time periods in which the at least one mode may be active, a periodicity for the at least one mode, one or more respective communication directions for the one or more time periods, or any combination thereof.

In some examples of the method, second network entities, and non-transitory computer-readable medium described herein, the one or more operations include a handover procedure, a scheduling procedure, or a determination of measurement gap information.

In some examples of the method, second network entities, and non-transitory computer-readable medium described herein, the communications device may be the first network entity, a UE, or a third network entity.

In some examples of the method, second network entities, and non-transitory computer-readable medium described herein, the first network entity may be a DU and the second network entity may be a CU.

A method for wireless communications by a UE is described. The method may include receiving one or more messages indicating duplex information for one or more cells associated with a first network entity, where the duplex information includes information related to a SBFD mode, a SBHD mode, a FD mode, or any combination thereof for the one or more cells, and communicating, via a cell of the one or more cells, with the first network entity in accordance with the duplex information.

A UE for wireless communications is described. The UE may include one or more memories storing processor executable code, and one or more processors coupled with the one or more memories. The one or more processors may individually or collectively be operable to execute the code to cause the UE to receive one or more messages indicating duplex information for one or more cells associated with a first network entity, where the duplex information includes information related to a SBFD mode, a SBHD mode, a FD mode, or any combination thereof for the one or more cells, and communicate, via a cell of the one or more cells, with the first network entity in accordance with the duplex information.

Another UE for wireless communications is described. The UE may include means for receiving one or more messages indicating duplex information for one or more cells associated with a first network entity, where the duplex information includes information related to a SBFD mode, a SBHD mode, a FD mode, or any combination thereof for the one or more cells, and means for communicating, via a cell of the one or more cells, with the first network entity in accordance with the duplex information.

A non-transitory computer-readable medium storing code for wireless communications is described. The code may include instructions executable by one or more processors to receive one or more messages indicating duplex information for one or more cells associated with a first network entity, where the duplex information includes information related to a SBFD mode, a SBHD mode, a FD mode, or any combination thereof for the one or more cells, and communicate, via a cell of the one or more cells, with the first network entity in accordance with the duplex information.

In some examples of the method, UEs, and non-transitory computer-readable medium described herein, the duplex information includes a set of multiple duplex configurations and the method, apparatuses, and non-transitory computer-readable medium may include further operations, features, means, or instructions for receiving a control message to activate one of the set of multiple duplex configurations, where the communicating with the first network entity may be in accordance with the activated one of the set of multiple duplex configurations.

In some examples of the method, UEs, and non-transitory computer-readable medium described herein, the control message may be a MAC-CE or a DCI message.

In some examples of the method, UEs, and non-transitory computer-readable medium described herein, the duplex information indicates an active mode for a first cell of the one or more cells, a random access channel configuration associated with an active mode for the first cell, or both, the active mode including, one or more of one of the SBFD mode, the SBHD mode, or the FD mode.

In some examples of the method, UEs, and non-transitory computer-readable medium described herein, the duplex information indicates frequency information for at least one mode from among the SBFD mode, the SBHD mode, or the FD mode, the frequency information including an uplink frequency range, a downlink frequency range, a guard band frequency range, or any combination thereof for the at least one mode, a SCS for the at least one mode, a frequency offset for the at least one mode, or any combination thereof.

In some examples of the method, UEs, and non-transitory computer-readable medium described herein, the duplex information indicates a type of frequency domain allocation for one or more time periods, the type of frequency domain allocation including a pattern of one or more downlink allocations and one or more uplink allocations within the one or more time periods.

In some examples of the method, UEs, and non-transitory computer-readable medium described herein, the duplex information indicates time information for at least one mode from among the SBFD mode, the SBHD mode, or the FD mode, the time information including one or more time periods in which the at least one mode may be active, a periodicity for the at least one mode, one or more respective communication directions for the one or more time periods, or any combination thereof.

In some examples of the method, UEs, and non-transitory computer-readable medium described herein, the one or more messages include one or more of a system information block, a RRC message, a MAC-CE, or DCI.

In some examples of the method, UEs, and non-transitory computer-readable medium described herein, the duplex information may be received from the first network entity.

In some examples of the method, UEs, and non-transitory computer-readable medium described herein, the duplex information may be received from a third network entity.

In some examples of the method, UEs, and non-transitory computer-readable medium described herein, the first network entity may be a DU.

### BRIEF DESCRIPTION OF THE DRAWINGS

FIG. 1 shows an example of a wireless communications system that supports duplex information exchange within a wireless communications network in accordance with one or more aspects of the present disclosure.

FIG. 2 shows an example of a wireless communications system that supports duplex information exchange within a wireless communications network in accordance with one or more aspects of the present disclosure.

FIG. 3 shows an example of a wireless communications system that supports duplex information exchange within a wireless communications network in accordance with one or more aspects of the present disclosure.

FIG. 4 shows an example of a process flow that supports duplex information exchange within a wireless communications network in accordance with one or more aspects of the present disclosure.

FIGS. 5 and 6 show block diagrams of devices that support duplex information exchange within a wireless communications network in accordance with one or more aspects of the present disclosure.

FIG. 7 shows a block diagram of a communications manager that supports duplex information exchange within a wireless communications network in accordance with one or more aspects of the present disclosure.

FIG. 8 shows a diagram of a system including a device that supports duplex information exchange within a wireless communications network in accordance with one or more aspects of the present disclosure.

FIGS. 9 and 10 show block diagrams of devices that support duplex information exchange within a wireless communications network in accordance with one or more aspects of the present disclosure.

FIG. 11 shows a block diagram of a communications manager that supports duplex information exchange within a wireless communications network in accordance with one or more aspects of the present disclosure.

FIG. 12 shows a diagram of a system including a device that supports duplex information exchange within a wireless communications network in accordance with one or more aspects of the present disclosure.

FIGS. 13 through 18 show flowcharts illustrating methods that support duplex information exchange within a wireless communications network in accordance with one or more aspects of the present disclosure.

### DETAILED DESCRIPTION

In some wireless communications systems, a network entity may communicate with a user equipment (UE) using one or more duplex modes (e.g., subband full-duplex (SBFD), subband half-duplex (SBHD), or full-duplex (FD) such as (IBFD)). For example, the network entity may transmit signaling to the UE and receive signaling from the UE via resources that overlap partially in time and/or frequency. However, in the case of distributed deployment scenarios, a central unit (CU) may perform one or more operations (e.g., handover procedure, measurement gap determination, scheduling) that may be affected by a duplex mode used by a distributed unit (DU) for communicating with a UE.

Accordingly, techniques described herein may allow for a DU to transmit backhaul signaling to a CU indicating duplex information. For example, the duplex information may indicate an active duplex mode (e.g., SBFD, SBHD, FD), frequency or time information related to one or more duplex modes, or a random access channel (RACH) configuration that is specific to one or more duplex modes. In some examples, the CU may forward the duplex information to another network entity (e.g., another CU or DU for use in a handover procedure). Additionally, or alternatively, one or more network entities (e.g., the DU, the CU, a different DU) may transmit the duplex information to the UE. For example, the one or more network entities may indicate multiple duplex configurations to the UE (e.g., via a system information block (SIB), radio resource control (RRC), medium access control-control element (MAC-CE), or downlink control information (DCI)), and may transmit signaling (e.g., via MAC-CE or DCI) activating one of the multiple duplex configurations.

Aspects of the disclosure are initially described in the context of wireless communications systems. Aspects of the disclosure are further illustrated by and described with reference to process flow diagrams, apparatus diagrams, system diagrams, and flowcharts that relate to duplex information exchange within a wireless communications network.

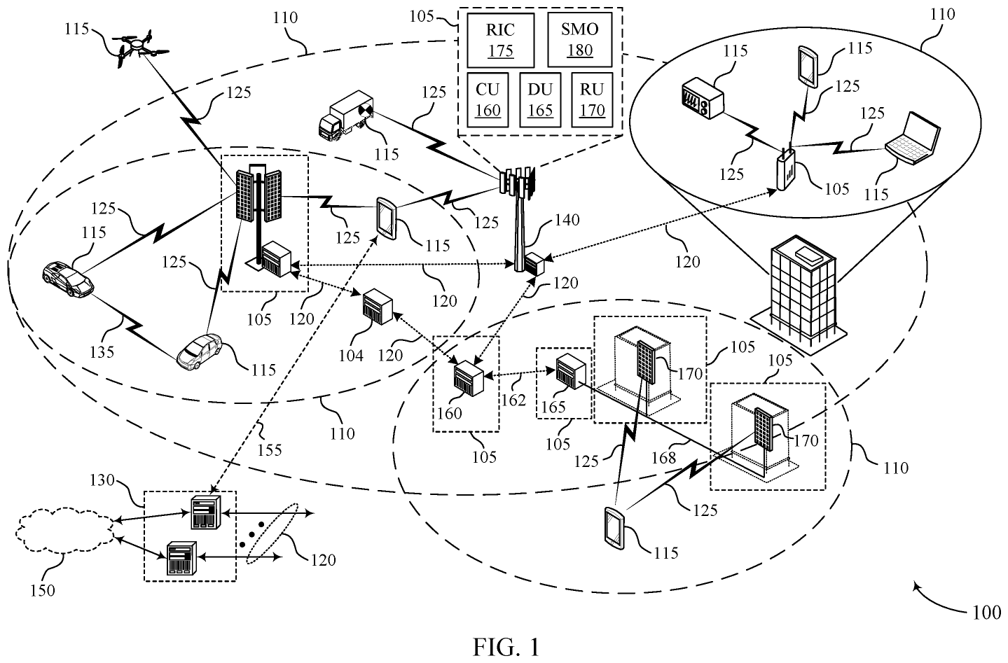

FIG. 1 shows an example of a wireless communications system 100 that supports duplex information exchange within a wireless communications network in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a CU 160, a DU 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support duplex information exchange within a wireless communications network as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a subband, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more subbands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples, the wireless communications system 100 may support half-duplex communications (e.g., frequency division duplexing (FDD) or time division duplexing (TDD), in which a UE 115 or a network entity 105 may perform communication of downlink signaling and communication of uplink signaling via resources that do not overlap in time or frequency, respectively. For example, for FDD operations, the network entity 105 may allocate a dedicated downlink transmission frequency bandwidth, a dedicated uplink transmission frequency bandwidth, and a dedicated supplementary uplink frequency bandwidth (e.g., defined by a central frequency and a frequency range or quantity of resource blocks (RBs)), and may schedule the downlink and uplink communications in overlapping time resources. For TDD operations, the network entity 105 may allocate a dedicated downlink and uplink transmission frequency bandwidth and a dedicated supplementary uplink frequency bandwidth (e.g., defined by a central frequency and a frequency range or quantity of RBs), and may schedule the downlink and uplink communications in non-overlapping time resources.

In some examples, the wireless communications system 100 may support full-duplex communications, in which a UE 115 or a network entity 105 may perform simultaneous communication of downlink signaling and communication of uplink signaling on a frequency subband basis (e.g., across a set of frequencies). For example, for SBFD communications, the network entity 105 may partition a particular frequency band (e.g., 100 MHz) into subbands which the network entity 105 may use exclusively for uplink or downlink communications. For example, the network entity 105 may use the 40 MHz of a 100 MHz band for downlink communications, 20 MHz for uplink communications, and another 40 MHz again for downlink communications. That is, the uplink and downlink subbands may have relatively similar frequencies, however, may be non-overlapping in frequency. Full-duplex communications may be suitable for macro cells with a large transmit power, and may be relatively simpler to enable than other full-duplex techniques. In some examples, such SBFD communication techniques may also support a dedicated frequency band for supplementary uplink communications, as described with reference to FDD and TDD communications.

To further enhance flexibility of some operations, the wireless communications system 100 may support UEs 115 and network entities 105 which may both perform simultaneous transmission and reception of downlink and uplink communications via partially or fully overlapping frequency bands. For example, the wireless communications system 100 may support a network entity 105 that operates using full-duplex communications via partially overlapping frequency bands, or a network entity 105 that operates using half-duplex communications (e.g., in a multi-transmission reception point (mTRP)) scenario) and a UE 115 that operates using full-duplex communications.

In some scenarios, network entities 105 in the wireless communications system 100 may support full-duplex operations (e.g., where a network entity 105 may communicate simultaneously on uplink and downlink subbands that are non-overlapping in frequency), while UEs 115 may support half-duplex communications. For example, the network entity 105 may use a particular subband for transmitting downlink communications to a first UE 115, and a particular subband for receiving simultaneous uplink communications from a second UE 115. As such, a UE 115 capable of half-duplex communications may be paired with any network entity 105 capable of full-duplex operations in the wireless communications system 100.

In some examples, the network entity 105 may use IBFD communications, in which the network entity 105 may transmit and receive communications with a UE 115 via a same time resource and a same frequency resource. That is, the downlink and uplink may share same IBFD time and frequency resources, which may partially or fully overlap. Alternatively, the network entity 105 may use SBFD (e.g., flexible duplex) communications, in which the network entity 105 may transmit and receive communications with the UE 115 via a same time resource but via different frequency resources. That is, a frequency resource used for downlink communications may be separated from a frequency resource used for uplink communications (e.g., by a guard band). In some examples, the network entity 105 may use SBHD, in which the network entity 105 may transmit and receive communications with the UE 115 via frequency subbands that do not overlap in time or frequency. Such techniques may allow for the network entity 105 to transition between a half-duplex mode (e.g., TDD or FDD) and a full-duplex mode (e.g., SBFD, IBFD).

In some examples, as described herein, a first network entity 105 (e.g., a DU 165) may transmit backhaul signaling to a second network entity 105 (e.g., a CU 160) indicating duplex information. For example, the duplex information may indicate an active duplex mode used by the first network entity 105 (e.g., SBFD, FD, SBHD), frequency or time information related to one or more duplex modes, or a random access channel (RACH) configuration that is specific to one or more duplex modes. In some examples, the second network entity 105 may forward the duplex information to another network entity 105 (e.g., another CU 160 or DU 165 for use in a handover procedure). Additionally, or alternatively, one or more network entities 105 may transmit the duplex information to a UE 115 in communication with the first network entity 105. For example, the one or more network entities 105 may indicate multiple duplex configurations to the UE 115 (e.g., via SIB, RRC, MAC-CE, or DCI), and may transmit signaling (e.g., via MAC-CE or DCI) activating one of the multiple duplex configurations.

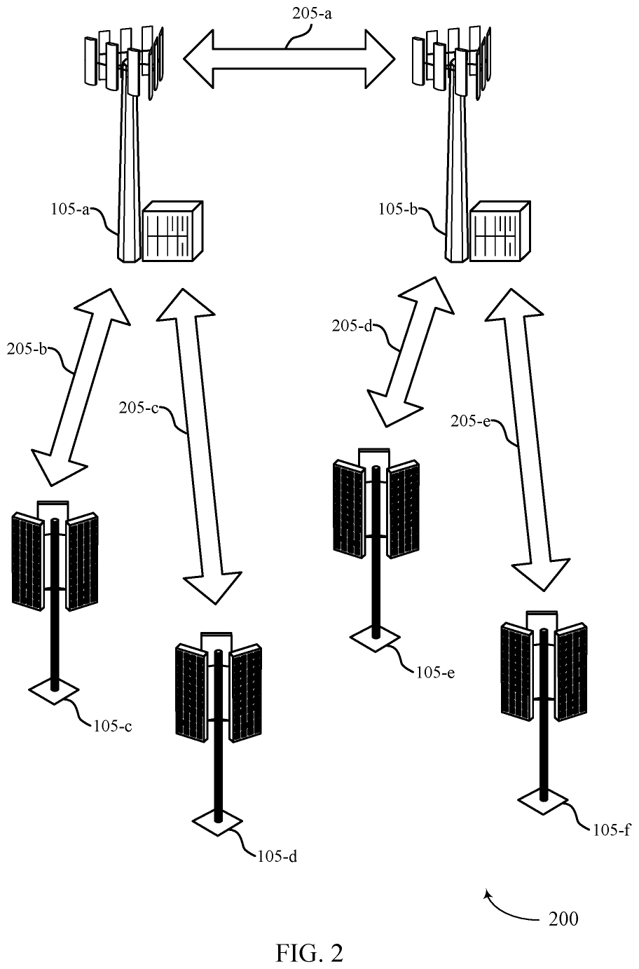

FIG. 2 shows an example of a wireless communications system 200 that supports duplex information exchange within a wireless communications network in accordance with one or more aspects of the present disclosure. The wireless communications system 200 may implement or may be implemented by aspects of the wireless communications system 100. For example, the wireless communications system 200 may include a UE 115 and one or more network entities 105 (e.g., a network entity 105-a through a network entity 105-f), which may be examples of the corresponding devices as described with reference to FIG. 1.

In some examples, the wireless communications system 200 may include one or more network entities 105 operating in a distributed architecture system. For example, a network entity 105-a may be an example of a CU, and may communicate with one or more DUs (e.g., a network entity 105-c, a network entity 105-d) via a backhaul communication link 205-b and a backhaul communication link 205-c, respectively. The network entity 105-a may communicate with one or more other CUs (e.g., a network entity 105-b) via a backhaul link 205-a. The network entity 105-b may also communicate with one or more DUs (e.g., a network entity 105-e, a network entity 105-f) via a backhaul communication link 205-d and a backhaul communication link 205-e, respectively.

In some examples, a CU (e.g., the network entity 105-a, the network entity 105-b) may perform one or more operations within wireless communication system. For example, the network entity 105-a may schedule one or more communications between the network entity 105-c and a UE 115 in the cell of the network entity 105-c. The network entity 105-a may, additionally, or alternatively, facilitate a handover procedure to handover the UE 115 from the network entity 105-c to the network entity 105-d (e.g., or to a DU associated with the network entity 105-b).

In some examples, the network entity 105-c (e.g., or one or more other DUs) may communicate with the UE 115 using a duplex mode (e.g., SBFD, SBHD, or FD). In such examples, the network entity 105-a may use information related to the duplex mode to perform the one or more operations. Accordingly, as described herein, the network entity 105-c may transmit, to the network entity 105-a via the backhaul communication link 205-b, information related to the duplex mode. For example, the network entity 105-c may indicate whether one or more cells served by the network entity 105-c or one or more beams used by the network entity 105-c are operating in a TDD mode, an FDD mode, a SBFD mode, a SBHD mode, or a FD mode, as well as carrier frequency information, transmission bandwidth information, etc.

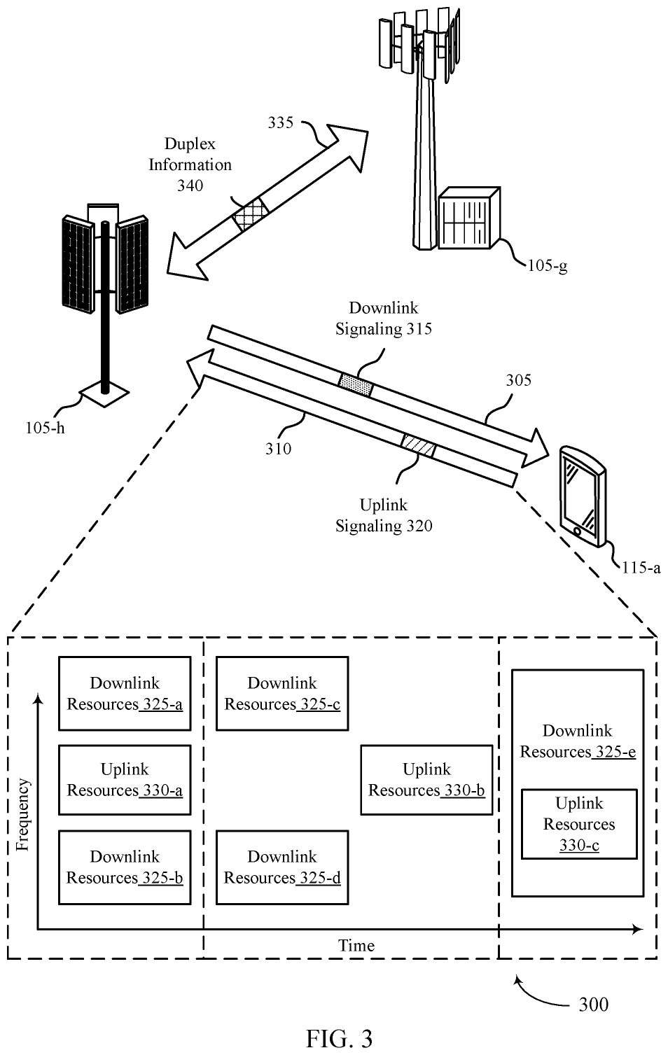

FIG. 3 shows an example of a wireless communications system 300 that supports duplex information exchange within a wireless communications network in accordance with one or more aspects of the present disclosure. The wireless communications system 300 may implement or may be implemented by aspects of the wireless communications system 100 or the wireless communications system 200. For example, the wireless communications system 300 may include a UE 115 (e.g., a UE 115-a) and one or more network entities 105 (e.g., a network entity 105-g and a network entity 105-h), which may be examples of the corresponding devices as described with reference to FIG. 1.

In some examples of the wireless communications system 300, a UE 115-a may communicate with a network entity 105-h (e.g., a DU). For example, the UE 115-a may transmit uplink signaling 320 to the network entity 105-h via an uplink channel 310 using uplink resources 330. The UE 115-a may receive downlink signaling 315 from the network entity 105-h via a downlink channel 305 using downlink resources 325.

In some examples, the network entity 105-h may operate using one or more duplex modes. For example, the network entity 105-h may operate using a SBFD mode, a SBHD mode, or a FD mode. In the SBFD mode, one or more downlink resources (e.g., downlink resource 325-a and downlink resources 325-b) may overlap in time with one or more uplink resources (e.g., uplink resources 330-a), but may be in frequency subbands separated in frequency from subbands containing the uplink resources (e.g., via a frequency guardband). In the SBHD mode, one or more downlink resources (e.g., downlink resource 325-c and downlink resources 325-d) may occupy a frequency subband, but may not overlap in time or frequency with one or more uplink resources (e.g., uplink resources 330-b) occupying a different frequency subband. In the FD mode, one or more downlink resources (e.g., downlink resources 325-e) may overlap in both time and frequency with one or more uplink resources (uplink resources 330-c). Thus, although FIG. 3 illustrate one example configuration of downlink resources 325 and uplink resources 330 relative to one another with a time domain and a frequency domain, alternative configurations are possible in accordance with the duplex modes (e.g., SBFD, SBHD, and FD modes) described herein, including alternative configurations in which uplink resources 330-b overlap in time with one or more of downlink resources 325-c and downlink resources 325-d.

In some examples, the network entity 105-h may communicate with a network entity 105-g (e.g., a CU) via a backhaul link 335. The network entity 105-h may perform one or more operations (e.g., coordinated scheduling operations, handover operations, measurement gap determination) with the network entity 105-h and one or more other DUs associated with the network entity 105-g, as described with reference to FIG. 2. In some examples, the network entity 105-g may use information related to the duplex modes used by the network entity 105-h to perform such operations. Accordingly, the network entity 105-h may transmit duplex information 340 via the backhaul communication link 335 to the network entity 105-g. In some examples, the network entity 105-h may transmit the duplex information 340 along with other served cell information including a new radio (NR) cell global identity (CGI), a NR physical cell identifier (PCI), a type allocation code (TAC), FDD or TDD information, cell direction, and RACH configurations.

In some aspects, duplex information 340 may include an active duplex mode (e.g., SBFD, SBHD, or FD) of the network entity 105-a, frequency or time related information, a duplex mode-specific RACH configuration (e.g., an information element indicating the RACH configuration or an indication of whether one or more RACH configurations is duplex mode-specific), or another cell-specific configuration. In some examples, the network entity 105-h may transmit the duplex information 340 to the network entity 105-g during an F1 setup procedure, a configuration update, or some other procedure. In some examples, the duplex information 340 may include one or multiple SBFD, SBHD, or FD configurations for each cell served by the network entity 105-h. In some examples, the duplex information 340 for a cell served by the network entity may include duplex information 340 for one or more beams within the cell. Thus, an example of duplex information may be beam information, and duplex information for a cell may be or include information about one or more beams associated (e.g., for use within) the cell. For example, the network entity 105-h may indicate multiple duplex configurations, and may indicate that one or more first duplex configurations will be active starting at a first timestamp during a first duration (e.g., in a time domain such as universal time coordinated (UTC) time or SFN). The network entity 105-h may indicate that one or more additional duplex configurations will be deactivated starting at a second timestamp during a second duration.

In some aspects, the duplex information 340 may include frequency related information for the SBFD, SBHD, or FD modes. For example, the duplex information 340 may indicate downlink subbands, uplink subbands, and guard bands associated with the SBFD, SBHD, or FD mode. In some examples, the subbands and guard bands may be defined as a starting physical resource block (PRB) with reference to a first frequency (e.g., a Point A or another reference frequency), a quantity of PRBs, and/or one or more resource block groups (RBGs). In some examples, the subbands and guard bands may be defined as a transmission bandwidth. The frequency information may further indicate a subcarrier spacing (SCS), a frequency offset (e.g., a parameter offsetToCarrier), and/or a type of domain allocation in one or more slots, symbols, or subframes. For example, the type of domain allocation may indicate that a series of slots, symbols, or subframes are dedicated for uplink or downlink transmissions.

In some aspects, the duplex information 340 may include time related information for the SBFD, SBHD, or FD modes. For example, the duplex information 340 may indicate one or more slots, frames, subframes, or symbols which can be used for the SBFD, SBHD, or FD modes (e.g., and downlink, uplink, or flexible slots, frames, subframes, or symbols). In some examples, the time information may indicate a starting and ending position (e.g., in absolute time); a cumulative quantity of slots, symbols, frames, or subframes associated with each duplex mode; or a pattern associated with switching between the duplex modes (e.g., and a periodicity associated with the pattern if the pattern repeats). In some examples, for the SBHD mode, the duplex information 340 may indicate whether each slot, symbol, frame, or subframe is specific to uplink or downlink; or whether each slot, symbol, frame, or subframe may be used for bidirectional communication (e.g., both uplink and downlink).

In some aspects, the network entity 105-g may forward the duplex information 340 (e.g., RACH configuration, active duplex mode information, time information, frequency information) associated with the network entity 105-h to one or more additional network entities 105 (e.g., another DU or another CU via F1 signaling or Xn signaling, respectively). For example, the network entity 105-h may transmit the duplex information 340 to a DU autonomously (e.g., via a CU configuration update message) or in response to a request from the DU (e.g., a request received via a DU configuration update acknowledgement). Additionally, or alternatively, the network entity 105-h may transmit the duplex information 340 to a CU autonomously (e.g., during an Xn setup procedure or RAN node configuration update) or in response to a request from the CU. The one or more additional network entities 105 may, for example, use the duplex information 340 to determine a suitable target for handover (e.g., for subsequent outgoing mobility involving the full-duplex aware UE 115-a) or for duplex-specific physical RACH (PRACH) configuration conflict mitigation.

In some aspects, the network entity 105-h, the network entity 105-g, or one or more additional network entities 105 may provide at least a subset of the duplex information to the UE 115-a (e.g., via the downlink channel 305, a different downlink channel, or a broadcast channel). For example, the network entity 105-h may receive a message from the network entity 105-g comprising at least the subset of the duplex information 340 for forwarding to the UE 115-a. The network entity 105-h may accordingly transmit the duplex information 340 to the UE 115-a (e.g., via SIB1 or a different SIB message, RRC, MAC-CE, or L1 signaling such as DCI). In some examples, the UE 115-a may receive the duplex information from a different network entity 105 via a broadcast message or from the network entity 105-g via RRC. In some examples, the UE 115-a may receive first duplex information via SIB and different duplex information via RRC. In such examples, the duplex information provided via RRC may override (e.g., take precedence over) duplex information received via SIB.

In some examples, the UE 115-a may receive multiple duplex configurations (e.g., SBFD, SBHD, or FD configurations). For example, the UE 115-a may receive an RRC message indicating the multiple duplex configurations. The UE 115-a may receive one or more additional messages (e.g., via L1 signaling such as DCI or L2 signaling such as MAC-CE) that may dynamically indicate one of the multiple duplex configurations for the UE 115-a to use in communicating with the network entity 105-h. In some examples, the UE 115-a may receive an indication from the network entity 105-h of a default duplex configuration. In some examples, the network entity 105-h may update the multiple duplex configurations (e.g., via SIB or other dedicated signaling).

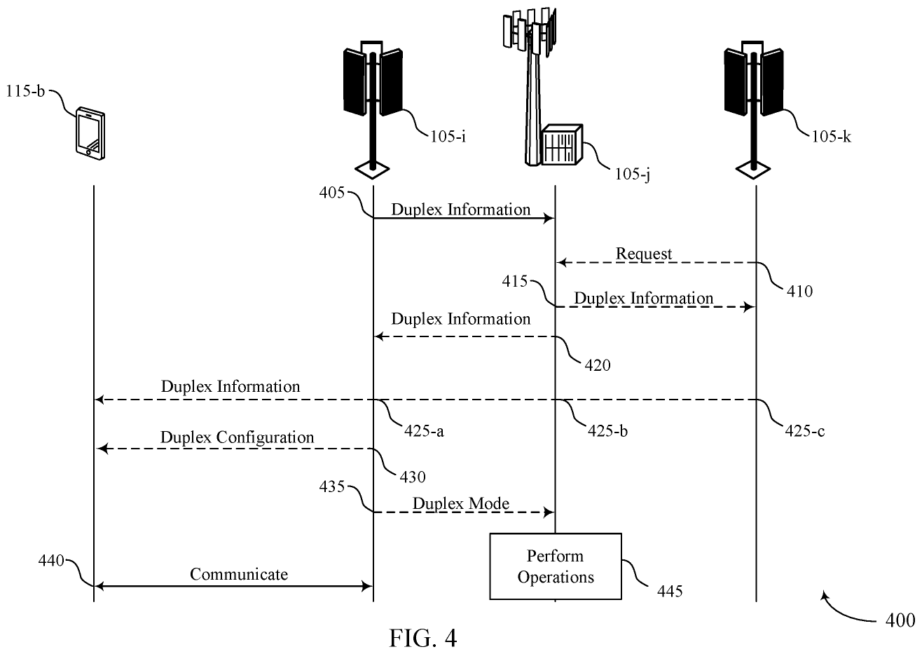

FIG. 4 shows an example of a process flow 400 that supports duplex information exchange within a wireless communications network in accordance with one or more aspects of the present disclosure. The process flow 400 may implement or may be implemented by aspects of the wireless communications system 100, the wireless communications system 200, or the wireless communications system 300. For example, the process flow 400 may be implemented by a UE 115 (e.g., a UE 115-b) and one or more network entities 105 (e.g., a network entity 105-i, a network entity 105-j, and a network entity 105-k), which may be examples of the corresponding devices as described with reference to FIG. 1. In some examples, the network entity 105-i may be an example of a DU. The network entity 105-j may be an example of a CU. The network entity 105-k may be an example of a DU or of a CU.

In the following description of the process flow 400, the operations between the UE 115-b, the network entity 105-i, the network entity 105-j, and the network entity 105-k may be transmitted in a different order than the example order shown. Some operations may also be omitted from the process flow 400, and other operations may be added to the process flow 400. Further, although some operations or signaling may be shown to occur at different times for discussion purposes, these operations may actually occur at the same time.

At 405, the network entity 105-i may output (e.g., provide, transmit), to the network entity 105-j, duplex information for one or more cells (e.g., or beams within a cell) used by the network entity 105-i. In some examples, the duplex information may include information related to a SBFD mode, a SBHD mode, or a FD mode used by the network entity 105-i. The duplex information may indicate, for example, an active duplex mode (e.g., SBFD, SBHD, or FD) used by a first cell of the one or more cells; a RACH configuration associated with a duplex mode (e.g., an active duplex mode); frequency information for the SBFD, SBHD; or FD modes, or time information for the SBFD, SBHD, or FD modes. In some examples, the duplex information may include multiple duplex configurations (e.g., multiple configurations for the SBFD, SBHD, and FD modes).

In some examples, the frequency information may include one or more of an uplink frequency range (e.g., an uplink subband), a downlink frequency range (e.g., a downlink subband), a guard band frequency range, a subcarrier spacing, or a frequency offset for one or more of the SBFD, SBHD, or FD modes. For example, the frequency information may identify one or more frequency bands, a starting frequency and a frequency range, a quantity of PRBs or RBGs, and so on. In some examples, the frequency information may indicate a type of frequency domain allocation for one or more time periods, such as a pattern of one or more uplink allocations and one or more downlink allocations within the one or more time periods.

In some examples, the time information may include one or more of one or more time periods in which the at least one mode is active, a periodicity for an allocation pattern (e.g., a pattern of uplink and downlink resources) for the at least one mode, or one or more respective communication directions (e.g., uplink or downlink) for the one or more time periods. In some examples, the time information may be specific to one or more of the SBFD, SBHD, and FD modes.

In some examples, at 410, the network entity 105-j may receive, from the network entity 105-k, a request for the duplex information. In some examples (e.g., if the network entity 105-k is a DU), the request may be in a configuration update acknowledgement message. The network entity 105-j may receive the request via F1 or Xn signaling.

In some examples, at 415, the network entity 105-j may output one or more messages to the network entity 105-k indicating the duplex information. The network entity 105-j may output the one or more message, for example, in response to the request or autonomously (e.g., in a configuration update message, during a setup procedure). The network entity 105-j may perform one or more operations (e.g., a handover procedure, PRACH conflict mitigation) based on receiving the duplex information.

In some examples, at 420, the network entity 105-j may output one or more messages to the network entity 105-i indicating the duplex information. For example, the network entity 105-j may output one or more messages indicating at least a subset of the duplex information for the network entity 105-i to forward to the UE 115-b.

In some examples, at 425-a, 425-b, or 425-c, the UE 115-b may receive one or more messages from the network entity 105-i, the network entity 105-j, or the network entity 105-k, respectively, indicating at least a subset of the duplex information. For example, the one or more messages may indicate one or more active duplex modes (e.g., of the SBFD, SBHD, and FD modes), the frequency information, the time information, or the one or more duplex-specific RACH configurations. In some examples, the one or more messages may indicate multiple duplex configurations (e.g., for the SBFD, SBHD, and/or FD modes). The one or more messages may be, for example, SIB messages, RRC messages, broadcast messages, MAC-CE messages, DCI messages, or some combination thereof. The one or more messages may be, for example, forwarded to the UE 115-b from the network entity 105-j by the network entity 105-i.

In some examples, at 430, the network entity 105-i may transmit, to the UE 115-b, a control message (e.g., a MAC-CE message or a DCI message) indicating a configuration of the multiple duplex configurations. That is, the control message may activate one of the multiple duplex configurations for the SBFD, SBHD, or FD modes for a cell of the network entity 105-i (e.g., a cell in which the UE 115-b operates).

In some examples, at 435, the network entity 105-i may transmit, to the network entity 105-h, a control message indicating a configuration of the multiple duplex configurations. That is, the control message may activate at least one of the multiple duplex configurations for the SBFD, SBHD, or FD modes (e.g., or indicate that one of the multiple duplex configurations is active) for one or more cells of the network entity 105-i. The control message may indicate at least time duration during which the activated duplex configurations are active.

At 440, the network entity 105-i may communicate with the UE 115-b via the cell according to the duplex information. That is, the network entity 105-i may communicate with the UE 115-b using the active duplex configuration (e.g., the SBFD, SBHD, or FD configuration activated by the control message), the frequency information, the time information, or the duplex mode-specific RACH configuration.

At 445, the network entity 105-j may perform one or more operations using the duplex information. For example, the network entity 105-j may perform a handover procedure, a scheduling procedure, determination of measurement gap information, or some combination thereof using the duplex information. For example, the network entity 105-j may initiate a handover procedure to handover the UE 115-b from the network entity 105-i to a different network entity 105 (e.g., the network entity 105-k) based on the duplex information.

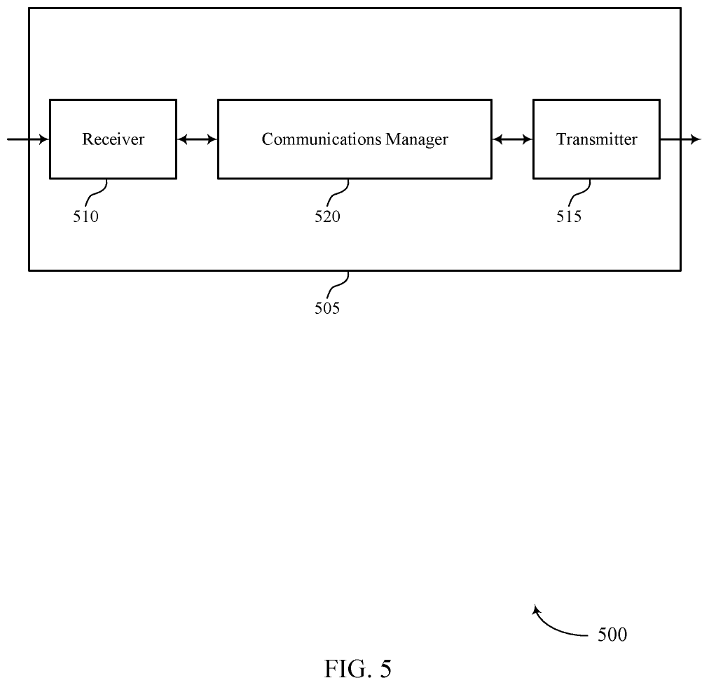

FIG. 5 shows a block diagram 500 of a device 505 that supports duplex information exchange within a wireless communications network in accordance with one or more aspects of the present disclosure. The device 505 may be an example of aspects of a network entity 105 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations thereof or various components thereof may be examples of means for performing various aspects of duplex information exchange within a wireless communications network as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for outputting duplex information for one or more cells associated with the first network entity, where the duplex information includes information related to a subband full-duplex mode, a subband half-duplex mode, a full-duplex mode, or any combination thereof for the one or more cells. The communications manager 520 is capable of, configured to, or operable to support a means for communicating, via a cell of the one or more cells, with a UE in accordance with the duplex information.

Additionally, or alternatively, the communications manager 520 may support wireless communications in accordance with examples as disclosed herein. For example, the communications manager 520 is capable of, configured to, or operable to support a means for obtaining duplex information for one or more cells associated with a first network entity, where the duplex information includes information related to a subband full-duplex mode, a subband half-duplex mode, a full-duplex mode, or any combination thereof for the one or more cells. The communications manager 520 is capable of, configured to, or operable to support a means for outputting, to a communications device, one or more messages indicating the duplex information. The communications manager 520 is capable of, configured to, or operable to support a means for performing one or more operations in accordance with the duplex information.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for transmitting backhaul signaling indicating duplex information, which may result in more efficient utilization of communication resources.

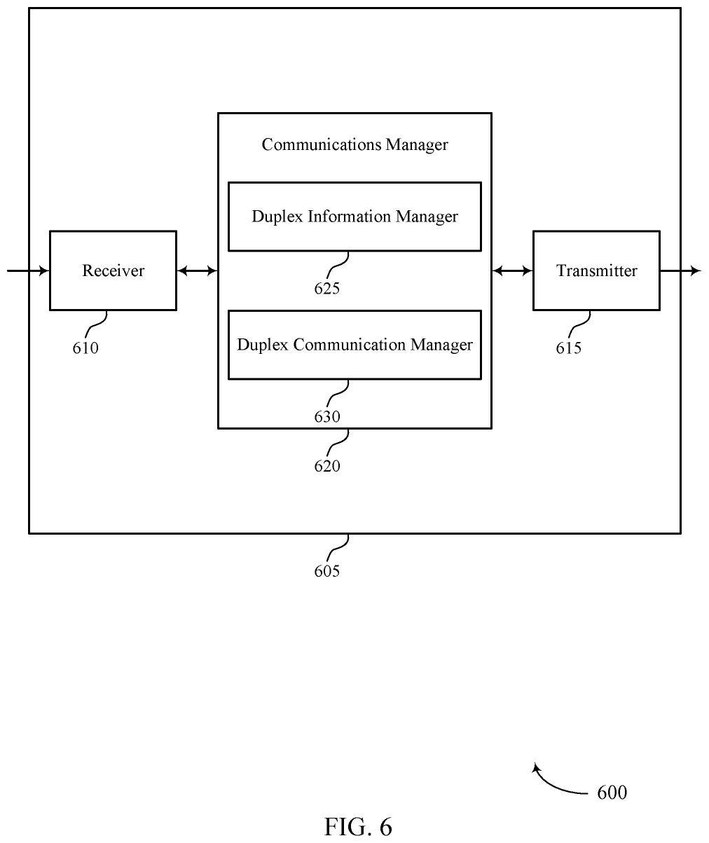

FIG. 6 shows a block diagram 600 of a device 605 that supports duplex information exchange within a wireless communications network in accordance with one or more aspects of the present disclosure. The device 605 may be an example of aspects of a device 505 or a network entity 105 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of duplex information exchange within a wireless communications network as described herein. For example, the communications manager 620 may include a duplex information manager 625 a duplex communication manager 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The duplex information manager 625 is capable of, configured to, or operable to support a means for outputting duplex information for one or more cells associated with the first network entity, where the duplex information includes information related to a subband full-duplex mode, a subband half-duplex mode, a full-duplex mode, or any combination thereof for the one or more cells. The duplex communication manager 630 is capable of, configured to, or operable to support a means for communicating, via a cell of the one or more cells, with a UE in accordance with the duplex information.

Additionally, or alternatively, the communications manager 620 may support wireless communications in accordance with examples as disclosed herein. The duplex information manager 625 is capable of, configured to, or operable to support a means for obtaining duplex information for one or more cells associated with a first network entity, where the duplex information includes information related to a subband full-duplex mode, a subband half-duplex mode, a full-duplex mode, or any combination thereof for the one or more cells. The duplex information manager 625 is capable of, configured to, or operable to support a means for outputting, to a communications device, one or more messages indicating the duplex information. The duplex information manager 625 is capable of, configured to, or operable to support a means for performing one or more operations in accordance with the duplex information.

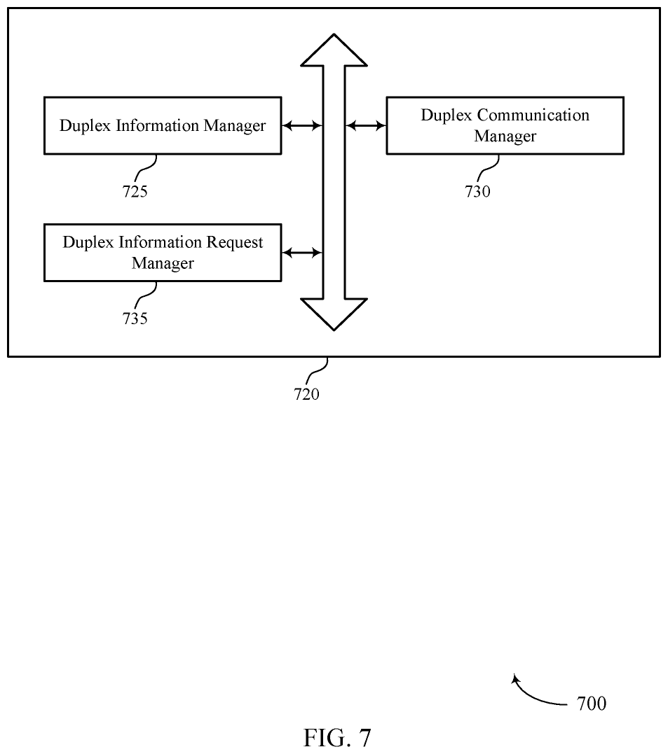

FIG. 7 shows a block diagram 700 of a communications manager 720 that supports duplex information exchange within a wireless communications network in accordance with one or more aspects of the present disclosure. The communications manager 720 may be an example of aspects of a communications manager 520, a communications manager 620, or both, as described herein. The communications manager 720, or various components thereof, may be an example of means for performing various aspects of duplex information exchange within a wireless communications network as described herein. For example, the communications manager 720 may include a duplex information manager 725, a duplex communication manager 730, a duplex information request manager 735, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications in accordance with examples as disclosed herein. The duplex information manager 725 is capable of, configured to, or operable to support a means for outputting duplex information for one or more cells associated with the first network entity, where the duplex information includes information related to a subband full-duplex mode, a subband half-duplex mode, a full-duplex mode, or any combination thereof for the one or more cells. The duplex communication manager 730 is capable of, configured to, or operable to support a means for communicating, via a cell of the one or more cells, with a UE in accordance with the duplex information.

In some examples, the duplex information is output to a second network entity, and the duplex information manager 725 is capable of, configured to, or operable to support a means for receiving, from the second network entity, a second message including at least a subset of the duplex information. In some examples, the duplex information is output to a second network entity, and the duplex information manager 725 is capable of, configured to, or operable to support a means for forwarding the second message to the UE.

In some examples, the duplex information includes a set of multiple duplex configurations, the set of multiple duplex configurations including one or more subband full-duplex configurations, subband half-duplex configurations, in-band full-duplex configurations, or any combination thereof, and the duplex information manager 725 is capable of, configured to, or operable to support a means for outputting a control message to activate one of the set of multiple duplex configurations, where the communicating with the UE is in accordance with the activated one of the set of multiple duplex configurations.

In some examples, the duplex information indicates an active duplex mode for a first cell of the one or more cells, a random access channel configuration associated with the active duplex mode for the first cell, or both, the active duplex mode including one or more of one of the subband full-duplex mode, the subband half-duplex mode, or the full-duplex mode.

In some examples, the duplex information indicates frequency information for at least one mode from among the subband full-duplex mode, the subband half-duplex mode, or the full-duplex mode, the frequency information including an uplink frequency range, a downlink frequency range, a guard band frequency range, or any combination thereof for the at least one mode, a subcarrier spacing for the at least one mode, a frequency offset for the at least one mode, or any combination thereof.

In some examples, the duplex information indicates a type of frequency domain allocation for one or more time periods, the type of frequency domain allocation including a pattern of one or more downlink allocations and one or more uplink allocations within the one or more time periods.

In some examples, the duplex information indicates time information for at least one mode from among the subband full-duplex mode, the subband half-duplex mode, or the full-duplex mode, the time information including one or more time periods in which the at least one mode is active, a periodicity for the at least one mode, one or more respective communication directions for the one or more time periods, or any combination thereof.

In some examples, the first network entity is a DU.

Additionally, or alternatively, the communications manager 720 may support wireless communications in accordance with examples as disclosed herein. In some examples, the duplex information manager 725 is capable of, configured to, or operable to support a means for obtaining duplex information for one or more cells associated with a first network entity, where the duplex information includes information related to a subband full-duplex mode, a subband half-duplex mode, a full-duplex mode, or any combination thereof for the one or more cells. In some examples, the duplex information manager 725 is capable of, configured to, or operable to support a means for outputting, to a communications device, one or more messages indicating the duplex information. In some examples, the duplex information manager 725 is capable of, configured to, or operable to support a means for performing one or more operations in accordance with the duplex information.

In some examples, the duplex information includes a set of multiple duplex configurations, the set of multiple duplex configurations including one or more subband full-duplex configurations, subband half-duplex configurations, in-band full-duplex configurations, or any combination thereof, and the duplex information manager 725 is capable of, configured to, or operable to support a means for obtaining a third message indicating at least one of the set of multiple duplex configurations.

In some examples, the third message indicates at least one time duration during which the at least one of the set of multiple duplex configuration is active.

In some examples, the duplex information request manager 735 is capable of, configured to, or operable to support a means for receiving, from a third network entity, a request for the duplex information, where outputting the duplex information to the communications device includes outputting the duplex information to the third network entity.

In some examples, the duplex information indicates an active duplex mode for the first cell, a random access channel configuration associated with the active duplex mode for the first cell, or both, the active duplex mode including one or more of the subband full-duplex mode, the subband half-duplex mode, or the full-duplex mode.

In some examples, the duplex information indicates frequency information for at least one mode from among the subband full-duplex mode, the subband half-duplex mode, or the full-duplex mode, the frequency information including an uplink frequency range, a downlink frequency range, a guard band frequency range, or any combination thereof for the at least one mode, a subcarrier spacing for the at least one mode, a frequency offset for the at least one mode, or any combination thereof.

In some examples, the duplex information indicates a type of frequency domain allocation for one or more time periods, the type of frequency domain allocation including a pattern of one or more downlink allocations and one or more uplink allocations within the one or more time periods.

In some examples, the duplex information indicates time information for at least one mode from among the subband full-duplex mode, the subband half-duplex mode, or the full-duplex mode, the time information including one or more time periods in which the at least one mode is active, a periodicity for the at least one mode, one or more respective communication directions for the one or more time periods, or any combination thereof.

In some examples, the one or more operations include a handover procedure, a scheduling procedure, or a determination of measurement gap information.

In some examples, the communications device is the first network entity, a UE, or a third network entity.

In some examples, the first network entity is a DU and the second network entity is a CU.

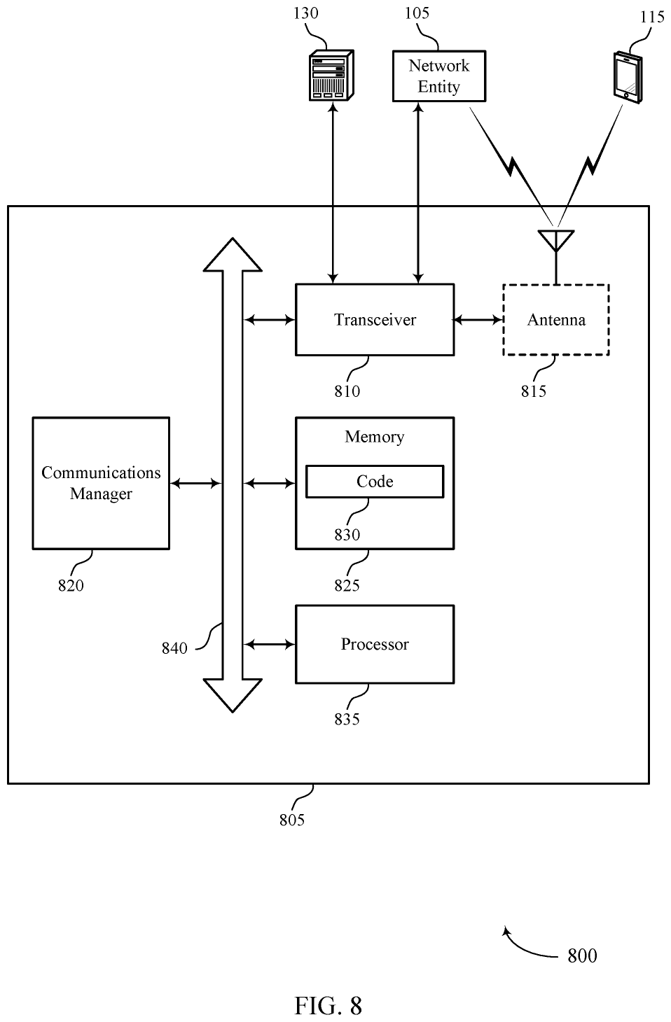

FIG. 8 shows a diagram of a system 800 including a device 805 that supports duplex information exchange within a wireless communications network in accordance with one or more aspects of the present disclosure. The device 805 may be an example of or include the components of a device 505, a device 605, or a network entity 105 as described herein. The device 805 may communicate with one or more network entities 105, one or more UEs 115, or any combination thereof, which may include communications over one or more wired interfaces, over one or more wireless interfaces, or any combination thereof. The device 805 may include components that support outputting and obtaining communications, such as a communications manager 820, a transceiver 810, an antenna 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., a communication link 125, a backhaul communication link 120, a midhaul communication link 162, a fronthaul communication link 168).

The at least one memory 825 may include RAM, ROM, or any combination thereof. The at least one memory 825 may store computer-readable, computer-executable code 830 including instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may contain, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting duplex information exchange within a wireless communications network). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825). In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. For example, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with other network entities 105, and may include a controller or scheduler for controlling communications with UEs 115 in cooperation with other network entities 105. In some examples, the communications manager 820 may support an X2 interface within an LTE/LTE-A wireless communications network technology to provide communication between network entities 105.

The communications manager 820 may support wireless communications in accordance with examples as disclosed herein. For example, the communications manager 820 is capable of, configured to, or operable to support a means for outputting duplex information for one or more cells associated with the first network entity, where the duplex information includes information related to a subband full-duplex mode, a subband half-duplex mode, a full-duplex mode, or any combination thereof for the one or more cells. The communications manager 820 is capable of, configured to, or operable to support a means for communicating, via a cell of the one or more cells, with a UE in accordance with the duplex information.

Additionally, or alternatively, the communications manager 820 may support wireless communications in accordance with examples as disclosed herein. For example, the communications manager 820 is capable of, configured to, or operable to support a means for obtaining duplex information for one or more cells associated with a first network entity, where the duplex information includes information related to a subband full-duplex mode, a subband half-duplex mode, a full-duplex mode, or any combination thereof for the one or more cells. The communications manager 820 is capable of, configured to, or operable to support a means for outputting, to a communications device, one or more messages indicating the duplex information. The communications manager 820 is capable of, configured to, or operable to support a means for performing one or more operations in accordance with the duplex information.

By including or configuring the communications manager 820 in accordance with examples as described herein, the device 805 may support techniques for transmitting backhaul signaling indicating duplex information, which may result in reduced latency, more efficient utilization of communication resources, and improved coordination between devices.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of duplex information exchange within a wireless communications network as described herein, or the at least one processor 835 and the at least one memory 825 may be otherwise configured to, individually or collectively, perform or support such operations.

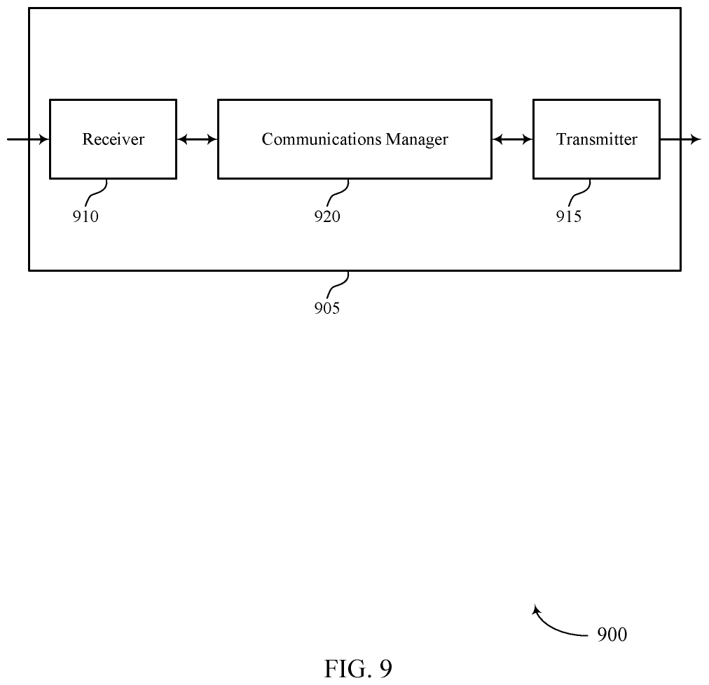

FIG. 9 shows a block diagram 900 of a device 905 that supports duplex information exchange within a wireless communications network in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to duplex information exchange within a wireless communications network). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to duplex information exchange within a wireless communications network). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of duplex information exchange within a wireless communications network as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving one or more messages indicating duplex information for one or more cells associated with a first network entity, where the duplex information includes information related to a subband full-duplex mode, a subband half-duplex mode, a full-duplex mode, or any combination thereof for the one or more cells. The communications manager 920 is capable of, configured to, or operable to support a means for communicating, via a cell of the one or more cells, with the first network entity in accordance with the duplex information.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for transmitting backhaul signaling indicating duplex information, which may result in more efficient utilization of communication resources.

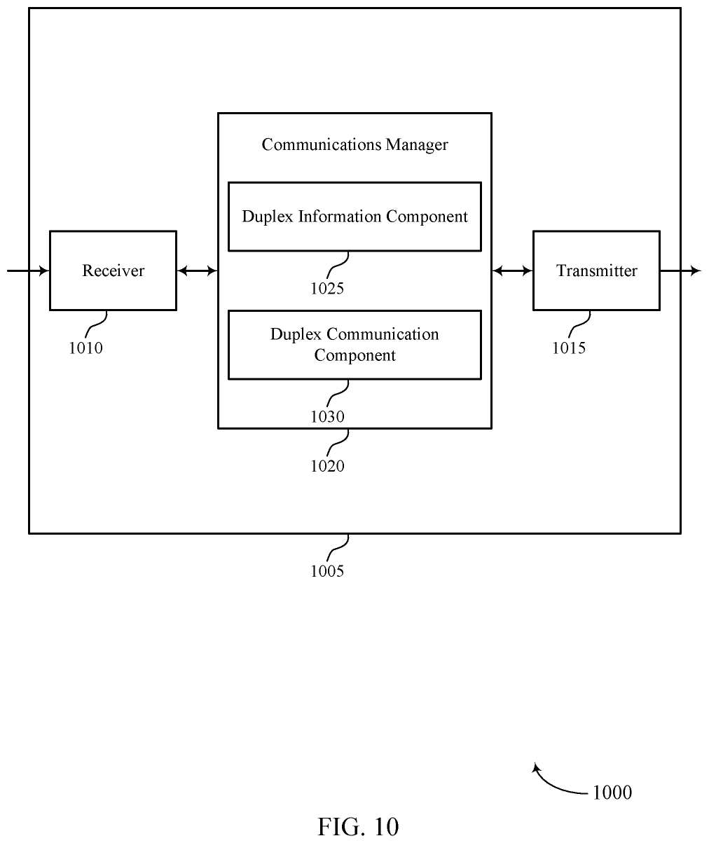

FIG. 10 shows a block diagram 1000 of a device 1005 that supports duplex information exchange within a wireless communications network in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to duplex information exchange within a wireless communications network). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to duplex information exchange within a wireless communications network). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of duplex information exchange within a wireless communications network as described herein. For example, the communications manager 1020 may include a duplex information component 1025 a duplex communication component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The duplex information component 1025 is capable of, configured to, or operable to support a means for receiving one or more messages indicating duplex information for one or more cells associated with a first network entity, where the duplex information includes information related to a subband full-duplex mode, a subband half-duplex mode, a full-duplex mode, or any combination thereof for the one or more cells. The duplex communication component 1030 is capable of, configured to, or operable to support a means for communicating, via a cell of the one or more cells, with the first network entity in accordance with the duplex information.

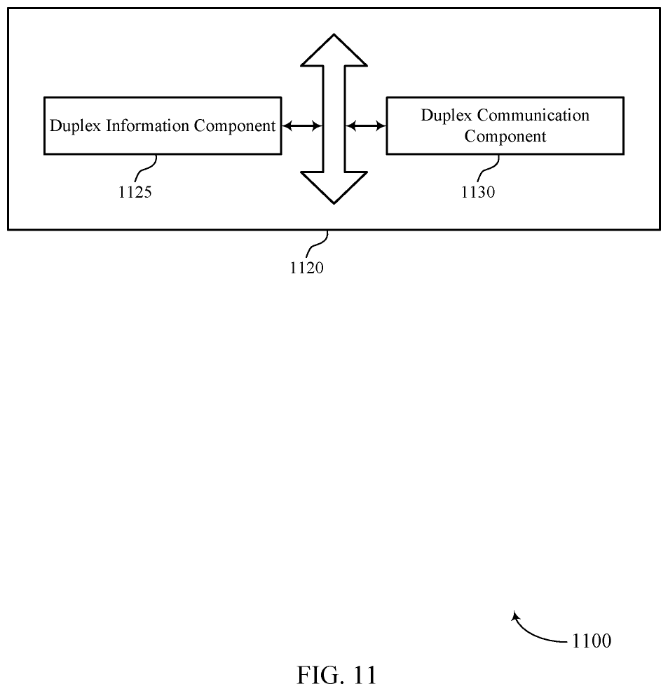

FIG. 11 shows a block diagram 1100 of a communications manager 1120 that supports duplex information exchange within a wireless communications network in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of duplex information exchange within a wireless communications network as described herein. For example, the communications manager 1120 may include a duplex information component 1125 a duplex communication component 1130, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The duplex information component 1125 is capable of, configured to, or operable to support a means for receiving one or more messages indicating duplex information for one or more cells associated with a first network entity, where the duplex information includes information related to a subband full-duplex mode, a subband half-duplex mode, a full-duplex mode, or any combination thereof for the one or more cells. The duplex communication component 1130 is capable of, configured to, or operable to support a means for communicating, via a cell of the one or more cells, with the first network entity in accordance with the duplex information.

In some examples, the duplex information includes a set of multiple duplex configurations, the set of multiple duplex configurations including one or more subband full-duplex configurations, subband half-duplex configurations, in-band full-duplex configurations, or any combination thereof, and the duplex information component 1125 is capable of, configured to, or operable to support a means for receiving a control message to activate one of the set of multiple duplex configurations, where the communicating with the first network entity is in accordance with the activated one of the set of multiple duplex configurations.

In some examples, the control message is or includes a MAC-CE or a DCI message.

In some examples, the duplex information indicates an active duplex mode for the first cell, a random access channel configuration associated with an active duplex mode for the first cell, or both, the active duplex mode including, one or more of one of the subband full-duplex mode, the subband half-duplex mode, or the full-duplex mode.

In some examples, the duplex information indicates frequency information for at least one mode from among the subband full-duplex mode, the subband half-duplex mode, or the full-duplex mode, the frequency information including an uplink frequency range, a downlink frequency range, a guard band frequency range, or any combination thereof for the at least one mode, a subcarrier spacing for the at least one mode, a frequency offset for the at least one mode, or any combination thereof.

In some examples, the duplex information indicates a type of frequency domain allocation for one or more time periods, the type of frequency domain allocation including a pattern of one or more downlink allocations and one or more uplink allocations within the one or more time periods.

In some examples, the duplex information indicates time information for at least one mode from among the subband full-duplex mode, the subband half-duplex mode, or the full-duplex mode, the time information including one or more time periods in which the at least one mode is active, a periodicity for the at least one mode, one or more respective communication directions for the one or more time periods, or any combination thereof.

In some examples, the one or more messages include one or more of a system information block, a RRC message, a MAC-CE, or DCI.

In some examples, the duplex information is received from the first network entity.

In some examples, the duplex information is received from a third network entity.

In some examples, the first network entity is a DU.

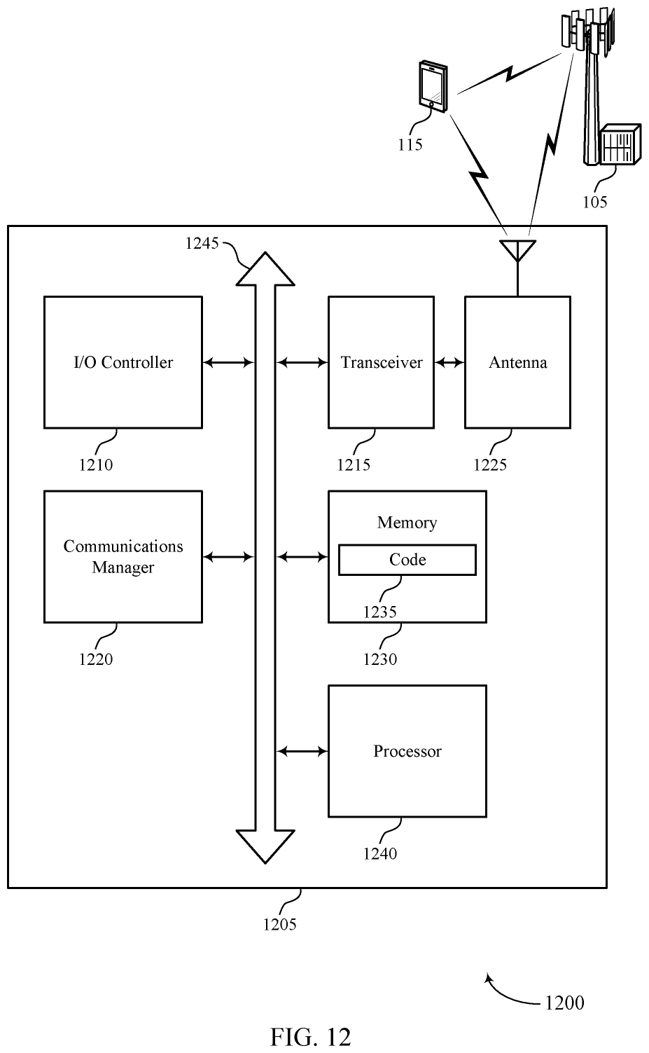

FIG. 12 shows a diagram of a system 1200 including a device 1205 that supports duplex information exchange within a wireless communications network in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable code 1235 including instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may contain, among other things, a basic I/O system (BIOS) which may control basic hardware or software operation such as the interaction with peripheral components or devices.

The at least one processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting duplex information exchange within a wireless communications network). For example, the device 1205 or a component of the device 1205 may include at least one processor 1240 and at least one memory 1230 coupled with or to the at least one processor 1240, the at least one processor 1240 and at least one memory 1230 configured to perform various functions described herein. In some examples, the at least one processor 1240 may include multiple processors and the at least one memory 1230 may include multiple memories. One or more of the multiple processors may be coupled with one or more of the multiple memories, which may, individually or collectively, be configured to perform various functions herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for receiving one or more messages indicating duplex information for one or more cells associated with a first network entity, where the duplex information includes information related to a subband full-duplex mode, a subband half-duplex mode, a full-duplex mode, or any combination thereof for the one or more cells. The communications manager 1220 is capable of, configured to, or operable to support a means for communicating, via a cell of the one or more cells, with the first network entity in accordance with the duplex information.

By including or configuring the communications manager 1220 in accordance with examples as described herein, the device 1205 may support techniques for transmitting backhaul signaling indicating duplex information, which may result in reduced latency, more efficient utilization of communication resources, and improved coordination between devices.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of duplex information exchange within a wireless communications network as described herein, or the at least one processor 1240 and the at least one memory 1230 may be otherwise configured to, individually or collectively, perform or support such operations.

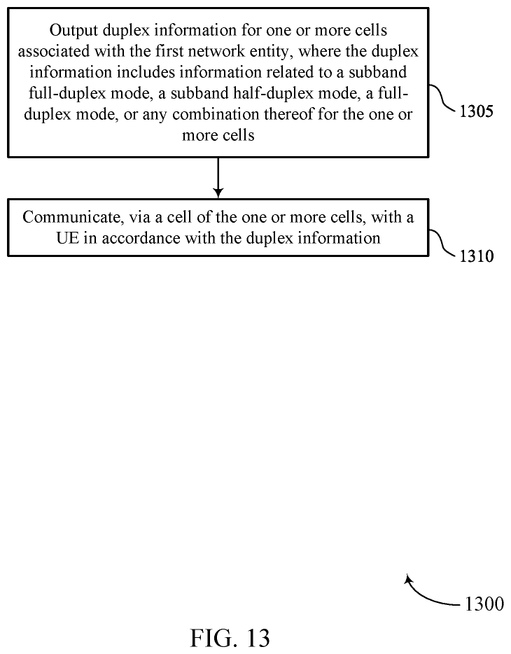

FIG. 13 shows a flowchart illustrating a method 1300 that supports duplex information exchange within a wireless communications network in accordance with one or more aspects of the present disclosure. The operations of the method 1300 may be implemented by a network entity or its components as described herein. For example, the operations of the method 1300 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1305, the method may include outputting duplex information for one or more cells associated with the first network entity, where the duplex information includes information related to a subband full-duplex mode, a subband half-duplex mode, a full-duplex mode, or any combination thereof for the one or more cells. The operations of 1305 may be performed in accordance with examples as disclosed herein. In some examples, aspects of the operations of 1305 may be performed by a duplex information manager 725 as described with reference to FIG. 7.

At 1310, the method may include communicating, via a cell of the one or more cells, with a UE in accordance with the duplex information. The operations of 1310 may be performed in accordance with examples as disclosed herein. In some examples, aspects of the operations of 1310 may be performed by a duplex communication manager 730 as described with reference to FIG. 7.

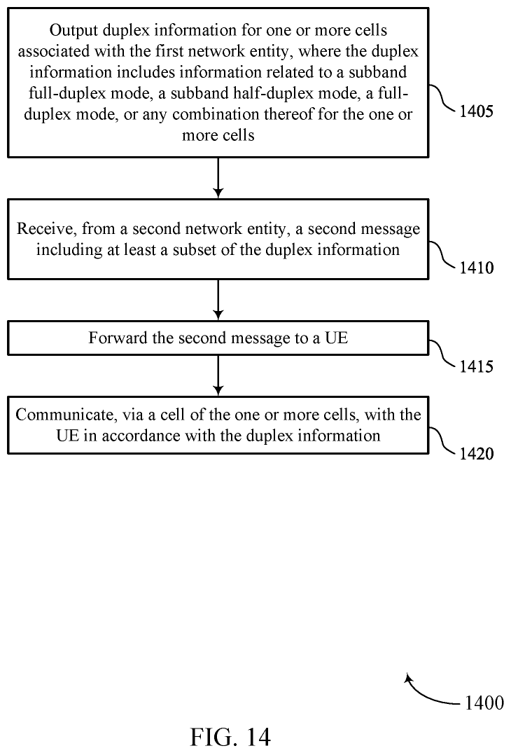

FIG. 14 shows a flowchart illustrating a method 1400 that supports duplex information exchange within a wireless communications network in accordance with one or more aspects of the present disclosure. The operations of the method 1400 may be implemented by a network entity or its components as described herein. For example, the operations of the method 1400 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1405, the method may include outputting duplex information for one or more cells associated with the first network entity, where the duplex information includes information related to a subband full-duplex mode, a subband half-duplex mode, a full-duplex mode, or any combination thereof for the one or more cells. The operations of 1405 may be performed in accordance with examples as disclosed herein. In some examples, aspects of the operations of 1405 may be performed by a duplex information manager 725 as described with reference to FIG. 7.

At 1410, the method may include receiving, from a second network entity, a second message including at least a subset of the duplex information. The operations of 1410 may be performed in accordance with examples as disclosed herein. In some examples, aspects of the operations of 1410 may be performed by a duplex information manager 725 as described with reference to FIG. 7.

At 1415, the method may include forwarding the second message to a UE. The operations of 1415 may be performed in accordance with examples as disclosed herein. In some examples, aspects of the operations of 1415 may be performed by a duplex information manager 725 as described with reference to FIG. 7.

At 1420, the method may include communicating, via a cell of the one or more cells, with the UE in accordance with the duplex information. The operations of 1420 may be performed in accordance with examples as disclosed herein. In some examples, aspects of the operations of 1420 may be performed by a duplex communication manager 730 as described with reference to FIG. 7.

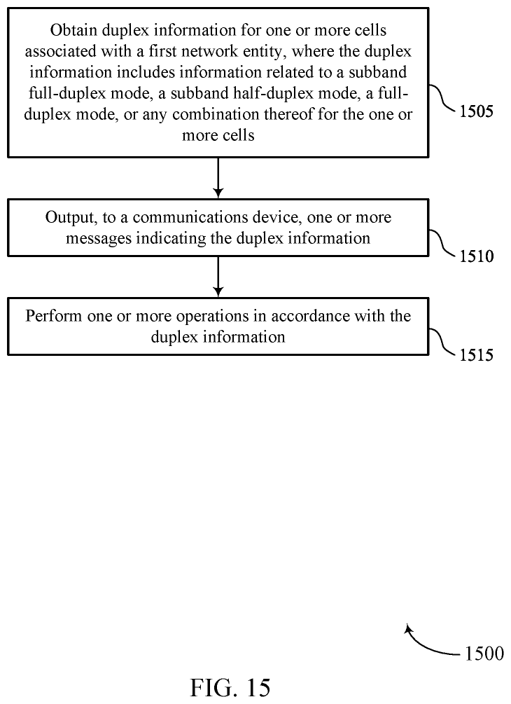

FIG. 15 shows a flowchart illustrating a method 1500 that supports duplex information exchange within a wireless communications network in accordance with one or more aspects of the present disclosure. The operations of the method 1500 may be implemented by a network entity or its components as described herein. For example, the operations of the method 1500 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1505, the method may include obtaining duplex information for one or more cells associated with a first network entity, where the duplex information includes information related to a subband full-duplex mode, a subband half-duplex mode, a full-duplex mode, or any combination thereof for the one or more cells. The operations of 1505 may be performed in accordance with examples as disclosed herein. In some examples, aspects of the operations of 1505 may be performed by a duplex information manager 725 as described with reference to FIG. 7.

At 1510, the method may include outputting, to a communications device, one or more messages indicating the duplex information. The operations of 1510 may be performed in accordance with examples as disclosed herein. In some examples, aspects of the operations of 1510 may be performed by a duplex information manager 725 as described with reference to FIG. 7.

At 1515, the method may include performing one or more operations in accordance with the duplex information. The operations of 1515 may be performed in accordance with examples as disclosed herein. In some examples, aspects of the operations of 1515 may be performed by a duplex information manager 725 as described with reference to FIG. 7.

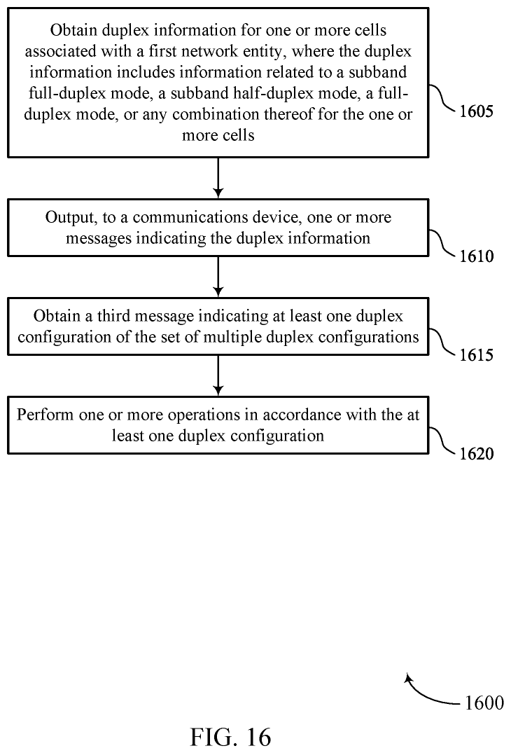

FIG. 16 shows a flowchart illustrating a method 1600 that supports duplex information exchange within a wireless communications network in accordance with one or more aspects of the present disclosure. The operations of the method 1600 may be implemented by a network entity or its components as described herein. For example, the operations of the method 1600 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1605, the method may include obtaining duplex information for one or more cells associated with a first network entity, where the duplex information includes information related to a subband full-duplex mode, a subband half-duplex mode, a full-duplex mode, or any combination thereof for the one or more cells. The operations of 1605 may be performed in accordance with examples as disclosed herein. In some examples, aspects of the operations of 1605 may be performed by a duplex information manager 725 as described with reference to FIG. 7.

At 1610, the method may include outputting, to a communications device, one or more messages indicating the duplex information. The operations of 1610 may be performed in accordance with examples as disclosed herein. In some examples, aspects of the operations of 1610 may be performed by a duplex information manager 725 as described with reference to FIG. 7.

At 1615, the method may include obtaining a third message indicating at least one duplex configuration of the set of multiple duplex configurations. The operations of 1615 may be performed in accordance with examples as disclosed herein. In some examples, aspects of the operations of 1615 may be performed by a duplex information manager 725 as described with reference to FIG. 7.

At 1620, the method may include performing one or more operations in accordance with the at least one duplex configuration. The operations of 1620 may be performed in accordance with examples as disclosed herein. In some examples, aspects of the operations of 1620 may be performed by a duplex information manager 725 as described with reference to FIG. 7.

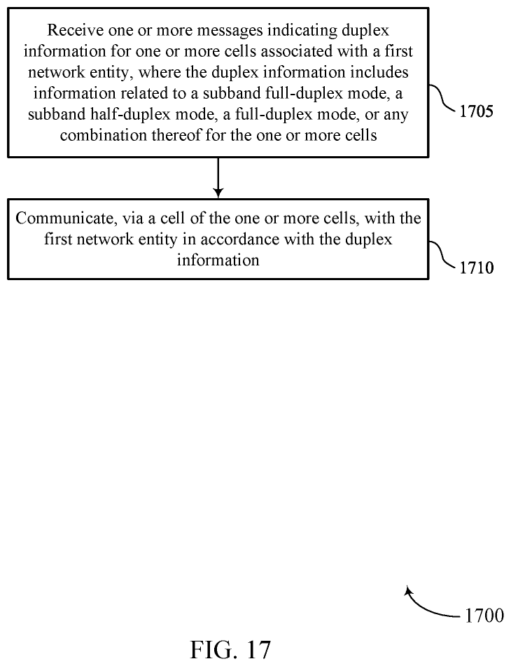

FIG. 17 shows a flowchart illustrating a method 1700 that supports duplex information exchange within a wireless communications network in accordance with one or more aspects of the present disclosure. The operations of the method 1700 may be implemented by a UE or its components as described herein. For example, the operations of the method 1700 may be performed by a UE 115 as described with reference to FIGS. 1 through 4 and 9 through 12. In some examples, a UE may execute a set of instructions to control the functional elements of the UE to perform the described functions. Additionally, or alternatively, the UE may perform aspects of the described functions using special-purpose hardware.

At 1705, the method may include receiving one or more messages indicating duplex information for one or more cells associated with a first network entity, where the duplex information includes information related to a subband full-duplex mode, a subband half-duplex mode, a full-duplex mode, or any combination thereof for the one or more cells. The operations of 1705 may be performed in accordance with examples as disclosed herein. In some examples, aspects of the operations of 1705 may be performed by a duplex information component 1125 as described with reference to FIG. 11.

At 1710, the method may include communicating, via a cell of the one or more cells, with the first network entity in accordance with the duplex information. The operations of 1710 may be performed in accordance with examples as disclosed herein. In some examples, aspects of the operations of 1710 may be performed by a duplex communication component 1130 as described with reference to FIG. 11.

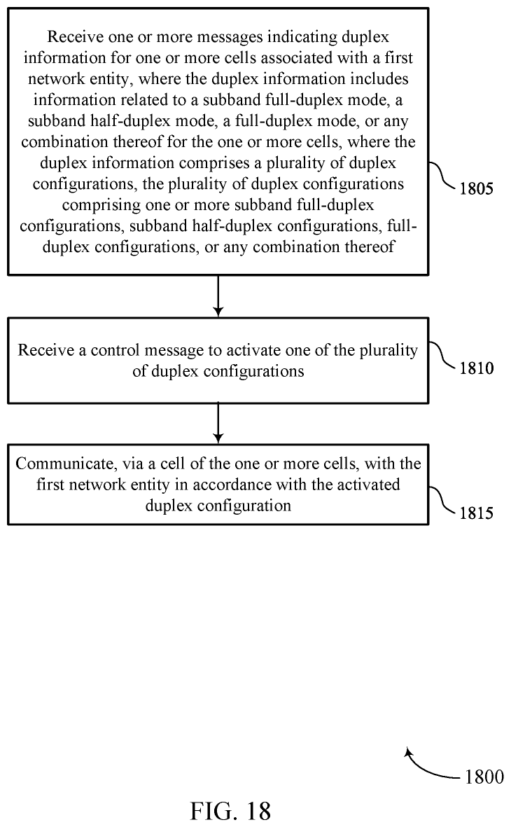

FIG. 18 shows a flowchart illustrating a method 1800 that supports duplex information exchange within a wireless communications network in accordance with one or more aspects of the present disclosure. The operations of the method 1800 may be implemented by a UE or its components as described herein. For example, the operations of the method 1800 may be performed by a UE 115 as described with reference to FIGS. 1 through 4 and 9 through 12. In some examples, a UE may execute a set of instructions to control the functional elements of the UE to perform the described functions. Additionally, or alternatively, the UE may perform aspects of the described functions using special-purpose hardware.

At 1805, the method may include receiving one or more messages indicating duplex information for one or more cells associated with a first network entity, where the duplex information includes information related to a subband full-duplex mode, a subband half-duplex mode, a full-duplex mode, or any combination thereof for the one or more cells. The duplex information may comprise a set of multiple duplex configurations, the set of multiple duplex configurations comprising one or more subband full-duplex configurations, subband half-duplex configurations, full-duplex configurations, or any combination thereof. The operations of 1805 may be performed in accordance with examples as disclosed herein. In some examples, aspects of the operations of 1805 may be performed by a duplex information component 1125 as described with reference to FIG. 11.

At 1810, the method may include receiving a control message to activate one of the set of multiple duplex configurations. The operations of 1810 may be performed in accordance with examples as disclosed herein. In some examples, aspects of the operations of 1810 may be performed by a duplex information component 1125 as described with reference to FIG. 11.

At 1815, the method may include communicating, via a cell of the one or more cells, with the first network entity in accordance with the duplex information, where the communicating with the first network entity is in accordance with the activated duplex configuration. The operations of 1815 may be performed in accordance with examples as disclosed herein. In some examples, aspects of the operations of 1815 may be performed by a duplex communication component 1130 as described with reference to FIG. 11.

The following provides an overview of aspects of the present disclosure:

Aspect 1: A method for wireless communications by a first network entity, comprising: outputting duplex information for one or more cells associated with the first network entity, wherein the duplex information comprises information related to a SBFD mode, a SBHD mode, a FD mode, or any combination thereof for the one or more cells; and communicating, via a cell of the one or more cells, with a UE in accordance with the duplex information.

Aspect 2: The method of aspect 1, wherein the duplex information is output to a second network entity, the method further comprising: receiving, from the second network entity, a second message comprising at least a subset of the duplex information; and forwarding the second message to the UE.

Aspect 3: The method of any of aspects 1 through 2, wherein the duplex information comprises a plurality of duplex configurations, the plurality of duplex configurations comprising one or more SBFD configurations, SBHD configurations, FD configurations, or any combination thereof, the method further comprising: outputting a control message to activate one of the plurality of duplex configurations, wherein the communicating with the UE is in accordance with the activated one of the plurality of duplex configurations.

Aspect 4: The method of any of aspects 1 through 3, wherein the duplex information indicates an active duplex mode for a first cell of the one or more cells, a random access channel configuration associated with an active duplex mode for the first cell, or both, the active duplex mode comprising, one or more of one of the SBFD mode, the SBHD mode, or the FD mode.

Aspect 5: The method of any of aspects 1 through 4, wherein the duplex information indicates frequency information for at least one mode from among the SBFD mode, the SBHD mode, or the FD mode, the frequency information comprising an uplink frequency range, a downlink frequency range, a guard band frequency range, or any combination thereof for the at least one mode, a SCS for the at least one mode, a frequency offset for the at least one mode, or any combination thereof.

Aspect 6: The method of any of aspects 1 through 5, wherein the duplex information indicates a type of frequency domain allocation for one or more time periods, the type of frequency domain allocation comprising a pattern of one or more downlink allocations and one or more uplink allocations within the one or more time periods.

Aspect 7: The method of any of aspects 1 through 6, wherein the duplex information indicates time information for at least one mode from among the SBFD mode, the SBHD mode, or the FD mode, the time information comprising one or more time periods in which the at least one mode is active, a periodicity for the at least one mode, one or more respective communication directions for the one or more time periods, or any combination thereof.

Aspect 8: The method of any of aspects 1 through 7, wherein the first network entity is a distributed unit (DU).

Aspect 9: A method for wireless communications by a second network entity, comprising: obtaining duplex information for one or more cells associated with a first network entity, wherein the duplex information comprises information related to a SBFD mode, a SBHD mode, a FD mode, or any combination thereof for the one or more cells; outputting, to a communications device, one or more messages indicating the duplex information; and performing one or more operations in accordance with the duplex information.

Aspect 10: The method of aspect 9, wherein the duplex information comprises a plurality of duplex configurations, the plurality of duplex configurations comprising one or more SBFD configurations, SBHD configurations, FD configurations, or any combination thereof, the method further comprising: obtaining a third message indicating at least one of the plurality of duplex configurations.

Aspect 11: The method of aspect 10, wherein the third message indicates at least one time duration during which the at least one of the plurality of duplex configuration is active.

Aspect 12: The method of any of aspects 9 through 11, further comprising: receiving, from a third network entity, a request for the duplex information, wherein outputting the duplex information to the communications device comprises outputting the duplex information to the third network entity.

Aspect 13: The method of any of aspects 9 through 12, wherein the duplex information indicates an active duplex mode for a first cell of the one or more cells, a random access channel configuration associated with an active duplex mode for the first cell, or both, the active duplex mode comprising one or more of the SBFD mode, the SBHD mode, or the FD mode.

Aspect 14: The method of any of aspects 9 through 13, wherein the duplex information indicates frequency information for at least one mode from among the SBFD mode, the SBHD mode, or the FD mode, the frequency information comprising an uplink frequency range, a downlink frequency range, a guard band frequency range, or any combination thereof for the at least one mode, a SCS for the at least one mode, a frequency offset for the at least one mode, or any combination thereof.

Aspect 15: The method of any of aspects 9 through 14, wherein the duplex information indicates a type of frequency domain allocation for one or more time periods, the type of frequency domain allocation comprising a pattern of one or more downlink allocations and one or more uplink allocations within the one or more time periods.

Aspect 16: The method of any of aspects 9 through 15, wherein the duplex information indicates time information for at least one mode from among the SBFD mode, the SBHD mode, or the FD mode, the time information comprising one or more time periods in which the at least one mode is active, a periodicity for the at least one mode, one or more respective communication directions for the one or more time periods, or any combination thereof.

Aspect 17: The method of any of aspects 9 through 16, wherein the one or more operations comprise a handover procedure, a scheduling procedure, or a determination of measurement gap information.

Aspect 18: The method of any of aspects 9 through 17, wherein the communications device is the first network entity, a UE, or a third network entity.

Aspect 19: The method of any of aspects 9 through 18, wherein the first network entity is a DU and the second network entity is a central unit (CU).

Aspect 20: A method for wireless communications by a UE, comprising: receiving one or more messages indicating duplex information for one or more cells associated with a first network entity, wherein the duplex information comprises information related to a SBFD mode, a SBHD mode, a FD mode, or any combination thereof for the one or more cells; and communicating, via a cell of the one or more cells, with the first network entity in accordance with the duplex information.

Aspect 21: The method of aspect 20, wherein the duplex information comprises a plurality of duplex configurations, the plurality of duplex configurations comprising one or more SBFD configurations, SBHD configurations, FD configurations, or any combination thereof, the method further comprising: receiving a control message to activate one of the plurality of duplex configurations, wherein the communicating with the first network entity is in accordance with the activated one of the plurality of duplex configurations.

Aspect 22: The method of aspect 21, wherein the control message is a MAC-CE or a DCI message.

Aspect 23: The method of any of aspects 20 through 22, wherein the duplex information indicates an active mode for a first cell of the one or more cells, a random access channel configuration associated with an active mode for the first cell, or both, the active mode comprising one or more of one of the SBFD mode, the SBHD mode, or the FD mode.

Aspect 24: The method of any of aspects 20 through 23, wherein the duplex information indicates frequency information for at least one mode from among the SBFD mode, the SBHD mode, or the FD mode, the frequency information comprising an uplink frequency range, a downlink frequency range, a guard band frequency range, or any combination thereof for the at least one mode, a SCS for the at least one mode, a frequency offset for the at least one mode, or any combination thereof.

Aspect 25: The method of any of aspects 20 through 24, wherein the duplex information indicates a type of frequency domain allocation for one or more time periods, the type of frequency domain allocation comprising a pattern of one or more downlink allocations and one or more uplink allocations within the one or more time periods.

Aspect 26: The method of any of aspects 20 through 25, wherein the duplex information indicates time information for at least one mode from among the SBFD mode, the SBHD mode, or the FD mode, the time information comprising one or more time periods in which the at least one mode is active, a periodicity for the at least one mode, one or more respective communication directions for the one or more time periods, or any combination thereof.

Aspect 27: The method of any of aspects 20 through 26, wherein the one or more messages comprise one or more of a system information block, a RRC message, a MAC-CE, or DCI.

Aspect 28: The method of any of aspects 20 through 27, wherein the duplex information is received from the first network entity.

Aspect 29: The method of any of aspects 20 through 28, wherein the duplex information is received from a third network entity.

Aspect 30: The method of any of aspects 20 through 29, wherein the first network entity is a DU.

Aspect 31: A first network entity for wireless communications, comprising one or more memories storing processor-executable code, and one or more processors coupled with the one or more memories and individually or collectively operable to execute the code to cause the first network entity to perform a method of any of aspects 1 through 8.

Aspect 32: A first network entity for wireless communications, comprising at least one means for performing a method of any of aspects 1 through 8.

Aspect 33: A non-transitory computer-readable medium storing code for wireless communications, the code comprising instructions executable by one or more processors to perform a method of any of aspects 1 through 8.

Aspect 34: A second network entity for wireless communications, comprising one or more memories storing processor-executable code, and one or more processors coupled with the one or more memories and individually or collectively operable to execute the code to cause the second network entity to perform a method of any of aspects 9 through 19.

Aspect 35: A second network entity for wireless communications, comprising at least one means for performing a method of any of aspects 9 through 19.

Aspect 36: A non-transitory computer-readable medium storing code for wireless communications, the code comprising instructions executable by one or more processors to perform a method of any of aspects 9 through 19.

Aspect 37: A UE for wireless communications, comprising one or more memories storing processor-executable code, and one or more processors coupled with the one or more memories and individually or collectively operable to execute the code to cause the UE to perform a method of any of aspects 20 through 30.

Aspect 38: A UE for wireless communications, comprising at least one means for performing a method of any of aspects 20 through 30.

Aspect 39: A non-transitory computer-readable medium storing code for wireless communications, the code comprising instructions executable by one or more processors to perform a method of any of aspects 20 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network entity, comprising:
one or more memories storing processor-executable code; and
one or more processors coupled with the one or more memories and individually or collectively operable to execute the code to cause the first network entity to:
output duplex information for one or more cells associated with the first network entity, wherein the duplex information comprises information related to a subband full-duplex mode, a subband half-duplex mode, a full-duplex mode, or any combination thereof for the one or more cells; and
communicate, via a cell of the one or more cells, with a user equipment (UE) in accordance with the duplex information.

2. The first network entity of claim 1, wherein, to output the duplex information, the one or more processors are individually or collectively operable to cause the first network entity to output the duplex information to a second network entity, and wherein the one or more processors are individually or collectively further operable to execute the code to cause the first network entity to:
receive, from the second network entity, a second message comprising at least a subset of the duplex information; and
forward the second message to the UE.

3. The first network entity of claim 1, wherein the duplex information comprises a plurality of duplex configurations, and wherein the one or more processors are individually or collectively further operable to execute the code to cause the first network entity to:
output a control message to activate one of the plurality of duplex configurations, wherein, to communicate with the UE in accordance with the duplex information, the one or more processors are individually or collectively operable to cause the first network entity to communicate with the UE in accordance with the activated one of the plurality of duplex configurations.

4. The first network entity of claim 1, wherein the duplex information indicates an active duplex mode for a first cell of the one or more cells, a random access channel configuration associated with the active duplex mode for the first cell, or both, the active duplex mode comprising one or more of one of the subband full-duplex mode, the subband half-duplex mode, or the full-duplex mode.

5. The first network entity of claim 1, wherein the duplex information indicates frequency information for at least one mode from among the subband full-duplex mode, the subband half-duplex mode, or the full-duplex mode, the frequency information comprising an uplink frequency range, a downlink frequency range, a guard band frequency range, or any combination thereof for the at least one mode, a subcarrier spacing for the at least one mode, a frequency offset for the at least one mode, or any combination thereof.

6. The first network entity of claim 1, wherein the duplex information indicates a type of frequency domain allocation for one or more time periods, the type of frequency domain allocation comprising a pattern of one or more downlink allocations and one or more uplink allocations within the one or more time periods.

7. The first network entity of claim 1, wherein the duplex information indicates time information for at least one mode from among the subband full-duplex mode, the subband half-duplex mode, or the full-duplex mode, the time information comprising one or more time periods in which the at least one mode is active, a periodicity for the at least one mode, one or more respective communication directions for the one or more time periods, or any combination thereof.

8. The first network entity of claim 1, wherein the first network entity is a distributed unit.

9. A second network entity, comprising:
one or more memories storing processor-executable code; and
one or more processors coupled with the one or more memories and individually or collectively operable to execute the code to cause the second network entity to:
obtain duplex information for one or more cells associated with a first network entity, wherein the duplex information comprises information related to a subband full-duplex mode, a subband half-duplex mode, a full-duplex mode, or any combination thereof for the one or more cells;
output, to a communications device, one or more messages indicating the duplex information; and
perform one or more operations in accordance with the duplex information.

10. The second network entity of claim 9, wherein the duplex information comprises a plurality of duplex configurations, and wherein the one or more processors are individually or collectively further operable to execute the code to cause the second network entity to:
obtain a third message indicating at least one of the plurality of duplex configurations.

11. The second network entity of claim 10, wherein the third message indicates at least one time duration during which the at least one of the plurality of duplex configurations is active.

12. The second network entity of claim 9, wherein the one or more processors are individually or collectively further operable to execute the code to cause the second network entity to:
receive, from a third network entity, a request for the duplex information, wherein, to output the duplex information to the communications device, the one or more processors are individually or collectively operable to execute the code to cause the second network entity to output the duplex information to the third network entity.

13. The second network entity of claim 9, wherein the duplex information indicates an active duplex mode for a first cell of the one or more cells, a random access channel configuration associated with the active duplex mode for the first cell, or both, the active duplex mode comprising one or more of the subband full-duplex mode, the subband half-duplex mode, or the full-duplex mode.

14. The second network entity of claim 9, wherein the duplex information indicates frequency information for at least one mode from among the subband full-duplex mode, the subband half-duplex mode, or the full-duplex mode, the frequency information comprising an uplink frequency range, a downlink frequency range, a guard band frequency range, or any combination thereof for the at one least mode, a subcarrier spacing for the at least one mode, a frequency offset for the at least one mode, or any combination thereof.

15. The second network entity of claim 9, wherein the duplex information indicates a type of frequency domain allocation for one or more time periods, the type of frequency domain allocation comprising a pattern of one or more downlink allocations and one or more uplink allocations within the one or more time periods.

16. The second network entity of claim 9, wherein the duplex information indicates time information for at least one mode from among the subband full-duplex mode, the subband half-duplex mode, or the full-duplex mode, the time information comprising one or more time periods in which the at least one mode is active, a periodicity for the at least one mode, one or more respective communication directions for the one or more time periods, or any combination thereof.

17. The second network entity of claim 9, wherein the one or more operations comprise a handover procedure, a scheduling procedure, or a determination of measurement gap information.

18. The second network entity of claim 9, wherein the communications device is the first network entity, a user equipment (UE), or a third network entity.

19. The second network entity of claim 9, wherein the first network entity is a distributed unit and the second network entity is a central unit.

20. A user equipment (UE), comprising:
one or more memories storing processor-executable code; and
one or more processors coupled with the one or more memories and individually or collectively operable to execute the code to cause the UE to:
receive one or more messages indicating duplex information for one or more cells associated with a first network entity, wherein the duplex information comprises information related to a subband full-duplex mode, a subband half-duplex mode, a full-duplex mode, or any combination thereof for the one or more cells; and
communicate, via a cell of the one or more cells, with the first network entity in accordance with the duplex information.

21. The UE of claim 20, wherein the duplex information comprises a plurality of duplex configurations, and wherein the one or more processors are individually or collectively further operable to execute the code to cause the UE to:
receive a control message to activate one of the plurality of duplex configurations, wherein, to communicate with the first network entity in accordance with the duplex information, the one or more processors are individually or collectively operable to execute the code to cause the UE to communicate with the first network entity in accordance with the activated one of the plurality of duplex configurations.

22. The UE of claim 21, wherein the control message comprises a medium access control-control element or a downlink control information message.

23. The UE of claim 20, wherein the duplex information indicates an active duplex mode for a first cell of the one or more cells, a random access channel configuration associated with the active duplex mode for the first cell, or both, the active duplex mode comprising, one or more of one of the subband full-duplex mode, the subband half-duplex mode, or the full-duplex mode.

24. The UE of claim 20, wherein the duplex information indicates frequency information for at least one mode from among the subband full-duplex mode, the subband half-duplex mode, or the full-duplex mode, the frequency information comprising an uplink frequency range, a downlink frequency range, a guard band frequency range, or any combination thereof for the at least one mode, a subcarrier spacing for the at least one mode, a frequency offset for the at least one mode, or any combination thereof.

25. The UE of claim 20, wherein the duplex information indicates a type of frequency domain allocation for one or more time periods, the type of frequency domain allocation comprising a pattern of one or more downlink allocations and one or more uplink allocations within the one or more time periods.

26. The UE of claim 20, wherein the duplex information indicates time information for at least one mode from among the subband full-duplex mode, the subband half-duplex mode, or the full-duplex mode, the time information comprising one or more time periods in which the at least one mode is active, a periodicity for the at least one mode, one or more respective communication directions for the one or more time periods, or any combination thereof.

27. The UE of claim 20, wherein the one or more messages comprise one or more of a system information block, a radio resource control message, a medium access control-control element, or downlink control information.

28. The UE of claim 20, wherein, to receive the duplex information, the one or more processors are individually or collectively operable to execute the code to cause the UE to receive the duplex information from the first network entity.

29. The UE of claim 20, wherein, to receive the duplex information, the one or more processors are individually or collectively operable to execute the code to cause the UE to receive the duplex information from a third network entity.

30. The UE of claim 20, wherein the first network entity is a distributed unit.
